(19) United States
(12) Patent Application Publication
(10) Pub. No.: US 2002/0193066 A1
(43) Pub. Date: Dec. 19, 2002

(54) Methods and apparatus for providing rating feedback for content in a broadcast system

(76) Inventor: Jay H. Connelly, Portland, OR (US)

Correspondence Address: Lance A. Termes, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/882,091

(22) Filed: Jun. 15, 2001

(51) Int. Cl. H04H 9/00

(52) U.S. Cl. 455/2.01; 455/1; 455/3.01

(57) ABSTRACT

Methods and apparatus for providing client feedback to a broadcast source to provide content on demand in broadcast systems. Client systems may tune-in to a stream of content descriptors that describe content in consideration for future broadcasting, and provide feedback in the form of ranking feedback or rating feedback to the broadcast source such that a list of desired content may be constructed in order to send content to the client systems on an as-needed basis or in batches.

### TECHNICAL FIELD OF THE INVENTION

This disclosure relates generally to broadcast systems, and more particularly, but not exclusively, to methods and apparatus for collecting client feedback from a plurality of client systems to provide content on demand in broadcast systems.

### BACKGROUND INFORMATION

Broadcast systems traditionally transmit data in one direction from a broadcasting source, such as an antenna, satellite, or a computer server system to a plurality of end user systems, which may typically comprise television receivers, cable boxes, set-top boxes, or client computers. For the purposes of the present disclosure, the broadcasting source will be referred to as a “server system,” and the end user systems will be referred to as “client systems,” or simply “clients.” Users of the client systems typically consume the signals received from the server system as they are broadcast. For example, broadcast signals corresponding to a live event are received substantially in real time. The same is true for other types of broadcast content, such as pre-recorded television shows and movies. Unlike live events, the data corresponding to pre-recorded shows and movies is stored somewhere in the broadcast system in advance.

Presently, a common content-delivery broadcasting method in which client end-users are provided with content involves server systems that broadcast the same data continuously and/or at staggered intervals. Thus, if a user desires to consume a particular data file on demand, the user “tunes in” to one of the repeated broadcasts of the data file. One example of this paradigm can be illustrated with present day “pay per view” movies that are available from cable or satellite television providers. For instance, cable television providers commonly broadcast the same movies repeatedly on multiple channels at staggered intervals. Users that wish to watch a particular movie “on demand” simply tune in to one of the channels on which the desired movie is broadcast at the beginning of one of the times that the movie is broadcast. The continuous and repeated broadcasts of the same data or programs results in a very inefficient use of broadcast bandwidth. Bandwidth used to broadcast the same data repeatedly on multiple channels could otherwise be used to broadcast different data.

Another paradigm for providing content on demand in a broadcast system involves a user recording a particular data file and later accessing the data file “on demand.” Continuing with the television broadcast illustration discussed above, an example of this paradigm is a user setting up his or her video cassette recorder (“VCR”) to record a desired television program. Later, when the user wishes to watch the television program “on demand,” the user simply plays the earlier recorded program from his or her VCR. Recently, more advanced digital video recorders have become available, which record the television broadcasts on internal hard drives instead of the video cassette tapes used by traditional VCRs. However, use, of the digital video recorders is similar to traditional VCRs in that the users are required to explicitly set the criteria used (e.g., date and/or time) to determine which broadcasts are recorded on the internal hard drives.

Another limitation with present day broadcast systems is that it is difficult for most users of the client systems to provide feedback to broadcasters with regard to programming. For example, continuing with the television broadcast illustration discussed above, many of today's television broadcasters rely upon Neilson ratings to determine broadcast programming and/or scheduling. Neilson ratings are generally based upon only a small sampling of a cross-section of the public. Consequently, most television viewers have relatively little or no impact on broadcast schedules and/or content.

### BRIEF DESCRIPTION OF THE VARIOUS VIEWS OF THE DRAWINGS

The present invention is illustrated by way of example and not limitation in the accompanying figures. Like reference numerals refer to like parts throughout the various views, and wherein:

FIG. 1A is a block diagram illustrating one embodiment of a broadcast system in accordance with the teachings of the present invention;

FIG. 1B is a block diagram illustrating another embodiment of a broadcast system in accordance with the teachings of the present invention;

FIG. 2 is a block diagram of one embodiment of a computer system representative of a client or a server in accordance with the teachings of the present invention;

FIG. 3 is a flow diagram illustrating one embodiment of the flow of events in a server and a client when broadcasting meta-data and data files, and the server receiving feedback data from the client(s) in accordance with the teachings of the present invention;

FIG. 4A is an illustration of an example broadcast system in accordance with the teachings of the present invention showing a broadcast operations center linked to a plurality of client systems via satellite links and a telecommunications network;

FIG. 4B is an illustration of an example broadcast system in accordance with the teachings of the present invention showing a broadcast operations center linked to a plurality of client systems via a bi-directional cable system;

FIG. 4C is an illustration of an example broadcast system in accordance with the teachings of the present invention showing a broadcast operations center linked to a plurality of client systems via a computer network;

FIG. 5 is a flow diagram illustrating one embodiment of the flow of events in a client when processing meta-data broadcast from a server to maintain a meta-data table and content rating table in accordance with the teachings of the present invention;

FIG. 6 is an illustration of one example of meta-data broadcast by a server to describe a plurality of data files in accordance with the teachings of the present invention;

FIG. 7 is an illustration of one example of a meta-data table updated and maintained by a client in accordance with the teachings of the present invention;

FIG. 8 is an illustration of one example of a content rating table updated and maintained by a client in accordance with the teachings of the present invention;

FIG. 9 is a diagram illustrating one embodiment of data files that are classified by a user in accordance with the teachings of the present invention;

FIG. 10 is a diagram illustrating one embodiment of a meta-data table that is updated in response to user classification in accordance with the teachings of the present invention;

FIG. 11 is a diagram illustrating one embodiment of a meta-data table that is updated after a user access in accordance with the teachings of the present invention;

FIG. 12 is a diagram illustrating one embodiment of a content rating table that is updated after a user access in accordance with the teachings of the present invention;

FIG. 13 is a diagram illustrating another embodiment of a meta-data table that is updated after another user access in accordance with the teachings of the present invention;

FIG. 14 is an illustration of an example user-interface display showing a format in which users may rate pieces of content;

FIGS. 15A-15C are illustrations of example user-interface displays showing a format in which users may rank pieces of content and how the ranking display may be updated; and

FIG. 16 is a pictorial illustration showing how an example broadcast operations center may broadcast communications to client systems located in various geographical areas.

### DETAILED DESCRIPTION OF THE ILLUSTRATED EMBODIMENTS

Embodiments of methods and apparatus for collecting client feedback from at least one client to provide content on demand in broadcast systems are described in detail herein. In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Futhermore, the particular features, structures, or characteristics may be combined in any suitable manner in one or more embodiments.

As an overview, embodiments of the invention provide a mechanism for collecting client feedback from at least one client in a broadcast system. Client systems may periodically tune-in to a stream of content descriptors and provide feedback to a broadcast operations center, ranking and/or rating the content descriptors for each piece of content. The broadcast operations center may then utilize the client feedback to construct an ordered list of desired content to send to the client systems on an as-needed basis, or in batches. Other features of the illustrated embodiments will be apparent to the reader from the foregoing and the appended claims, and as the detailed description and discussion is read in conjunction with the accompanying drawings.

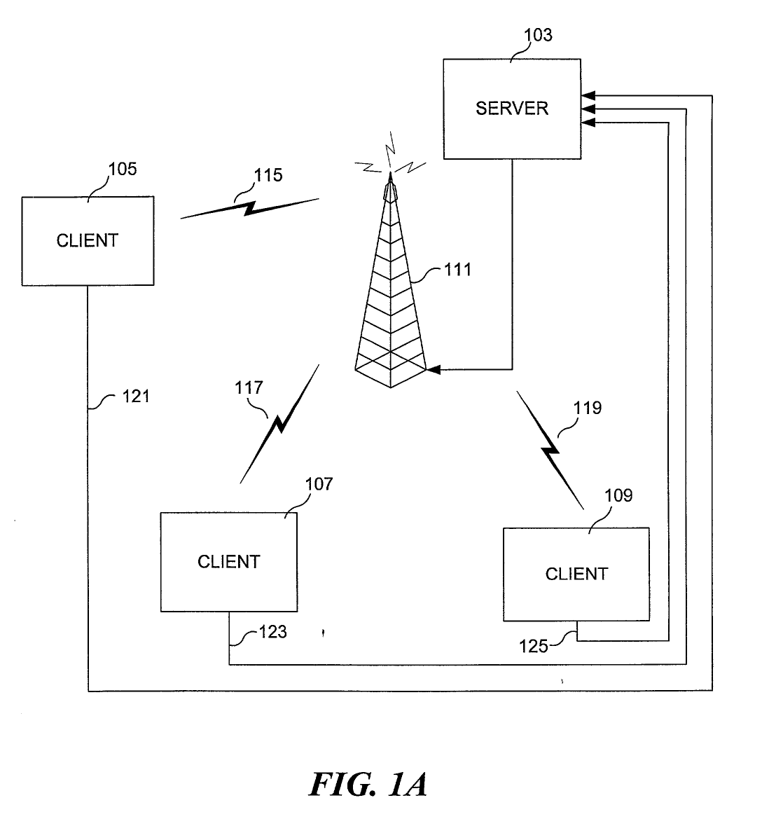

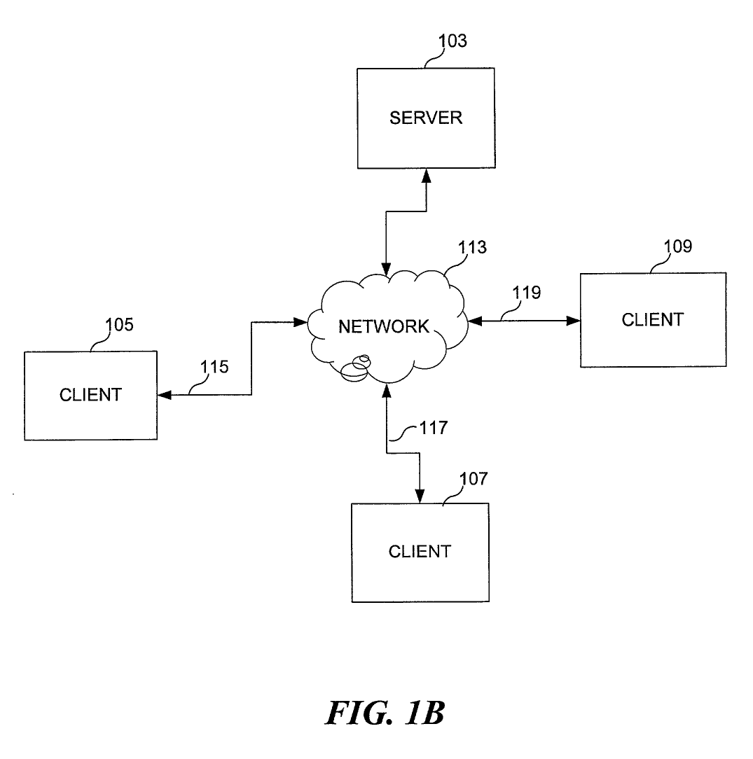

Referring now to the drawings, and in particular to FIG. 1A, there is illustrated one embodiment of a broadcast system in accordance with the teachings of the present invention. As illustrated in the depicted embodiment, a server 103 is configured to broadcast information to a plurality of clients 105, 107, and 109. In the embodiment shown in FIG. 1A, the client 105 receives a broadcast from the server 103 through a link 115 from a broadcast antenna 111. Similarly, the client 107 receives a broadcast from the server 103 through a link 117, and the client 109 receives a broadcast from the server 103 through a link 119 from the broadcast antenna 111. The links 115, 117, and 119 may be uni-directional wireless radio frequency (“RF”) links from the broadcast antenna 111 in a format such as for example, but not limited to, known amplitude modulation (“AM”) or frequency modulation (“FM”) radio signals, television (“TV”) signals, digital video broadcast (“DVB”) signals, or the like, which are broadcast through the atmosphere.

In an embodiment, the server 103 is configured to broadcast a plurality of data files, which may be received by the clients 105, 107, and 109. The data files may be any combination of a number of different types of files including for example video, audio, graphics, text, multi-media or the like. For purposes of explanation, many of the examples provided in this disclosure to help describe the present invention assume that the data files to be broadcast by the server are audio/video files, such as for example, movies with moving images and sound. However, it will be appreciated that the data files broadcast in accordance with the teachings of the present invention are not limited only to audio/video files.

As illustrated in the embodiment shown in FIG. 1A, there may be, in addition to the one-way or unidirectional link (e.g., reference numeral 115, 117, or 119) between the server 103 and each of the clients 105, 107, and 109, a communications link or “back channel” between each client 105, 107, and 109, and the server 103. The links 121, 123, and 125 may be used by the clients 105, 107, and 109, respectively, to send information back to the server 103. Although the links 121, 123, and 125 are illustrated in FIG. 1A as direct links between the clients 105, 107, and 109, and the server 103, it will be appreciated that the clients 105, 107, and 109 may communicate information to the server 103 through indirect links such as for example, but not limited to, broadcasted wireless signals, network communications, or the like. In other embodiments, the “back channel” may be connected to a remote location linked to the server, which may be a part of a broadcast operations center.

Turning our attention now primarily to FIG. 1B, there is an illustration of another embodiment of a broadcast system in accordance with the teachings of the present invention. As shown, the server 103 is coupled to a network 113 to broadcast information to a plurality of clients 105, 107, and 109 via the network 113. In one embodiment, the network 113 may be any type of communications network through which a plurality of different devices may communicate, such as for example, but not limited to, the Internet, a wide area network (“WAN”), a local area network (“LAN”), an intranet, or the like.

In the embodiment illustrated in FIG. 1B, the client 105 is coupled to receive information broadcast from the server 103 through a link 115. Similarly, the client 107 is coupled to receive information broadcast from the server 103 through a link 117, and the client 109 is coupled to receive information broadcast from the server 103 through a link 119. In the illustrated embodiment, each of the links, 115, 117, and 119 is bi-directional in nature, thereby enabling the clients 105, 107, and 109 to communicate information to the server 103 via the network 113. It will be appreciated that the links 115, 117, and 119 may be uni-directional in nature, and there may be a separate communications link or “back channel” through which each of the clients 105, 107, and 109 communicate with the server 103, or communicate with an alternate remote location linked to the server, which may comprise a part of the broadcast operations center. As illustrated by FIGS. 1A and 1B, and the foregoing description, a first communications link between the server 103 and the plurality of client systems 105, 107, and 109, and a second communications link between each of the plurality of client systems and the server, may comprise a common transmission platform, such as a bi-directional cable or the like, in an embodiment. In other embodiments, the first and second communications links may comprise separate transmission platforms, such as a satellite broadcast and a telecommunications back channel, or other combination, as desired or available based on the communications infrastructure in the particular locale in which the broadcast server or client systems are located.

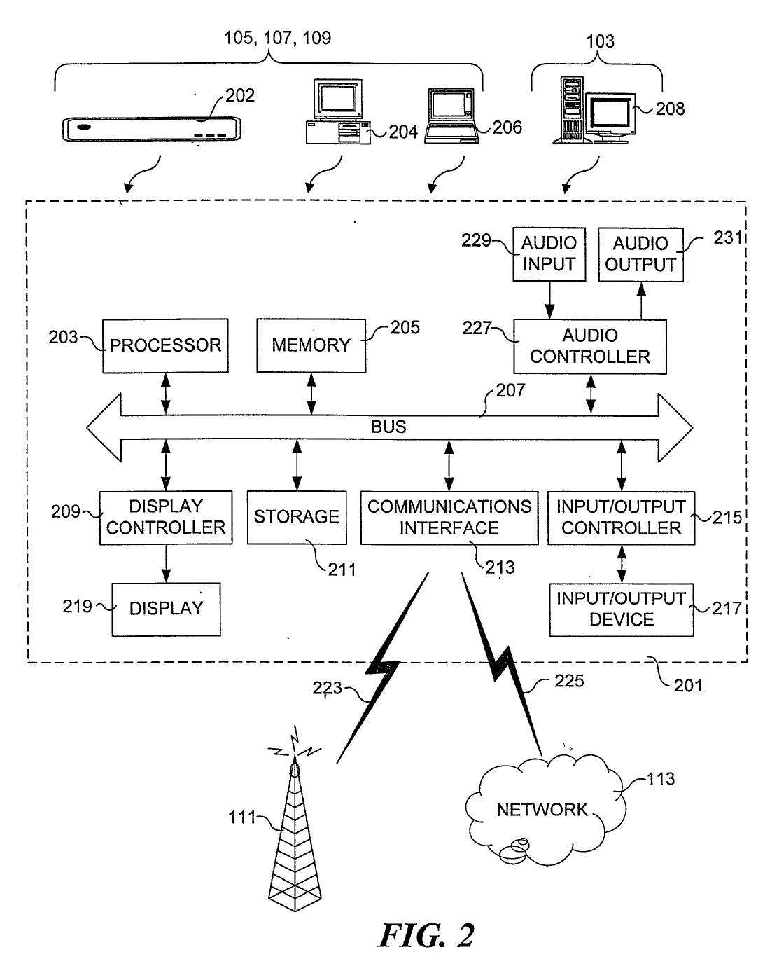

FIG. 2 is a block diagram illustrating one embodiment of a machine 201 that may be used for the server 103, or the clients 105, 107, or 109 in accordance with the teachings of the present invention. Typically, clients 103, 105, and 107 may use various types of machines, including a set-top box 202, desktop computer or workstation 204, or laptop computer 206. The machine used for the server 103 will typically comprise a computer server 208 or similar type of server hardware that is designed to broadcast data to a plurality of clients. In one embodiment, the machine 201 is a computer or a set-top-box that includes a processor 203 coupled to a bus 207. In one embodiment, a memory 205, a storage 211, a display controller 209, a communications interface 213, an input/output controller 215, and an audio controller 227 are also coupled to the bus 207.

In one embodiment, the machine 201 interfaces to external systems through the communications interface 213. The communications interface 213 may include a radio transceiver compatible with AM, FM, TV, digital TV, DVB, wireless telephone signals, or the like. The communications interface 213 may also include an analog modem, Integrated Services Digital Network (“ISDN”) modem, cable modem, Digital Subscriber Line (“DSL”) modem, a T-1 line interface, a T-3 line interface, an optical carrier interface (e.g., OC-3), token ring interface, satellite transmission interface, a wireless interface, or other interfaces for coupling a device to other devices.

In one embodiment, a carrier wave signal 223 is received/transmitted by the communications interface 213 to communicate with the antenna 111. In one embodiment, a carrier wave signal 225 is received/transmitted between the communications interface 213 and the network 113. In one embodiment, the communications signal 225 may be used to interface the machine 201 with another computer system, a network hub, a router, or the like. In one embodiment, the carrier wave signals 223 and 225 are considered to be machine-readable media, which may be transmitted through wires, cables, optical fibers, or through the atmosphere, or the like.

In one embodiment, the processor 203 may be a conventional processor, such as for example, but not limited to, an Intel x86 processor, or Pentium family microprocessor, a Motorola family microprocessor, or the like. The memory 205 may be a machine-readable medium such as dynamic random access memory (“DRAM”), and may include static random access memory (“SRAM”). The display controller 209 controls, in a conventional manner, a display 219, which in one embodiment may be a cathode ray tube (“CRT”), a liquid crystal display (“LCD”), an active matrix display, a television monitor, or the like. An input/output device 217, coupled to the input/output controller 215 may be a keyboard, a disk drive, a printer, a scanner, or other input/output device, including a television remote, a mouse, a trackball, a trackpad, a joystick, or the like. In one embodiment, the audio controller 227 controls in a conventional manner an audio output 231, which may include for example, audio speakers, headphones, an audio receiver, an amplifier, or the like. In one embodiment, the audio controller 227 also controls, in a conventional manner, an audio input 229, which may include for example, a microphone, or input(s) from an audio or musical device, or the like.

Storage 211, in one embodiment, may include machine readable media such as for example, but not limited to, a magnetic hard disk, a floppy disk, an optical disk, a read-only memory component (“ROM”), a smart card, or another form of storage for data. In one embodiment, the storage 211 may include removable media, read-only memory, readable/writable memory, or the like. Some of the data may be written by a direct memory access process into the memory 205 during execution of software in the computer system 201. It will be appreciated that software may reside in the storage 211, the memory 205, or may be transmitted or received via a modem or a communications interface 213. For the purpose of the specification, the term “machine-readable medium” shall be taken to include any medium that is capable of storing data, information, or encoding a sequence of instructions or operations for execution by the processor 203 to cause the processor 203 to perform the methodologies of the present invention. The term “machine-readable medium” shall be understood to include, for example, solid-state memories; ROM; random access memory (“RAM”); magnetic disk storage media; optical storage media; flash memory devices; electrical, optical, acoustical or other form of propagated signals (e.g., carrier tones, infrared signals, and digital signals); and the like.

In one embodiment, a broadcast system, such as for example, one similar to either of those illustrated in FIGS. 1A or 1B, is configured to have a server 103 broadcast a plurality of data files to a plurality of clients 105, 107, and 109. As will be discussed in greater detail below, each of the plurality of data files may be described with meta-data in accordance with teachings of one embodiment of the present invention. In general, meta-data can be considered as a set of descriptors or attribute values that describe content pieces or data files to be broadcast or potentially broadcast from the server 103. The meta-data of the present invention provides information that enables the client systems 105, 107, and 109 to reason and make informed decisions regarding the content of data files to be broadcast later by the server 103. As will be discussed, various embodiments of the present invention utilize the meta-data for client-side filtering, storage management and other personalization techniques as well as to determine broadcast schedules and content of future server broadcasts.

The present invention addresses many of the inadequacies in the prior art relating to the broadcasting of undesired content by providing a method and system that broadcasts content based on client feedback information. The present disclosure outlines a mechanism for generating optimized broadcast schedules whereby content description information, or content descriptors, corresponding to various pieces of content, or data files, (e.g., movies, pre-recorded and live TV shows, and the like) that may be broadcast by a broadcast operations center, is periodically broadcast to client systems, whereupon the client systems rate and/or rank the pieces of content using either user feedback, or automatic feedback, which may be generated via implementation of a ranking algorithm or a rating algorithm, in various embodiments.

The ranking and/or rating algorithms may be stored in the memory 205, in an embodiment, and may be performed by the processor 203. In one embodiment, the ranking and/or rating algorithms may include a consideration of a user's previous viewing habits to generate the ranking and/or rating feedback, respectively. In various embodiments, the ranking and/or rating algorithms may include a consideration of any existing cached data files maintained on the client system, a consideration of a content piece's revenue generating potential, which may be included as data in the content descriptors corresponding to the content piece, or a consideration of a content piece's size, which may also be included as data in the content descriptors corresponding to the content piece, to generate the ranking and/or rating feedback. In other embodiments, the ranking and/or rating algorithms may include a consideration of a user's preferences or a user's age, either or both of which may be stored in the memory 205 of the client system in one embodiment, in the memory 205 of the server system in another embodiment, or in other storage, to generate the ranking and/or rating feedback. In still other embodiments, the ranking and/or rating algorithms may include a consideration of an availability window corresponding to a content piece (e.g., the content piece will be available for a defined period of time), which may be included as data in the content descriptors corresponding to the content piece, or a consideration of a future broadcast schedule (e.g., when might the content piece next be available for caching), which may also be included as data in the content descriptors corresponding to the content piece, to generate the ranking and/or rating feedback. In yet other embodiments, the ranking and/or rating algorithms may include a consideration of a content piece's past revenue performance (e.g., box office receipts), which may be included as data in the content descriptors corresponding to the content piece, a consideration of a review of the content piece provided by an external source (e.g., the Motion Picture Association of America), which may also be included as data in the content descriptors corresponding to the content piece, or a consideration of a content piece's duration, which may also be included as data in the content descriptors corresponding to the content piece, to generate the ranking and/or rating feedback.

In addition, a combination of user feedback and automatic feedback may be used. Feedback from the client systems, which may comprise ranking feedback, rating feedback, or a combination of the two, may then be forwarded back to the broadcast operations center for generating or updating a list of content to be broadcast based on the client system's feedback information. Pieces of content are then broadcast to the client systems, whereupon the client systems can selectively determine which, if any of the pieces of content that are broadcast should be cached by that client system for subsequent “on demand” viewing. This process is repeated continuously, enabling the broadcast operations center to optimize its broadcast schedule based on client system feedback rather that having to use a conventional predetermined broadcast schedule.

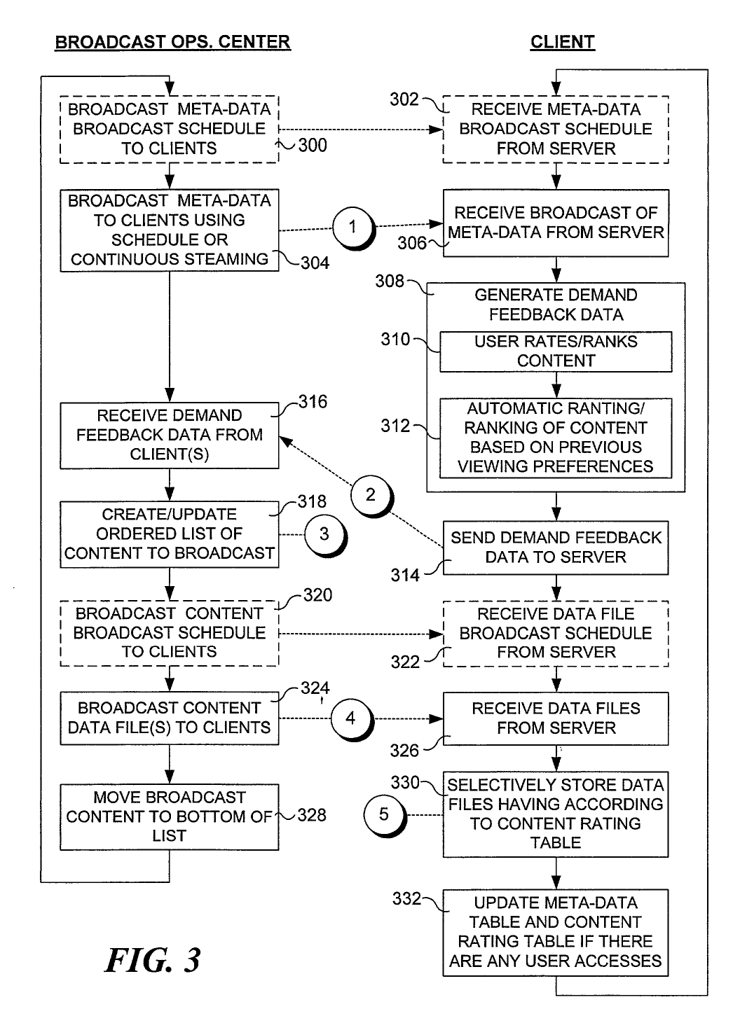

With reference now primarily to FIG. 3 there is illustrated a flow diagram depicting an embodiment showing the flow of events in a server (at, for example, a broadcast operations center) and a client in a broadcast system in which broadcast content and schedules are determined in response to client rankings and/or ratings in accordance with the teachings of the present invention. As discussed above, the first task is to provide content description information to the various client systems that may desire to view content provided by the broadcast operations center. In one embodiment, the content description information is sent as meta-data comprising a set of content descriptors for each piece of content that is considered for the broadcast schedule. In general, the content descriptors may be sent as a continuous stream of data, which the client systems can tap into at any point in time to capture the content description information. As necessary, the content descriptor stream may be preceded by an announcement of where the stream is and how to locate it. The content descriptor meta-data may also be sent as a file on a period basis. In one embodiment, a trigger may be sent to signal the client systems that the content description file is about to be sent so those client systems can receive and store the content descriptor meta-data.

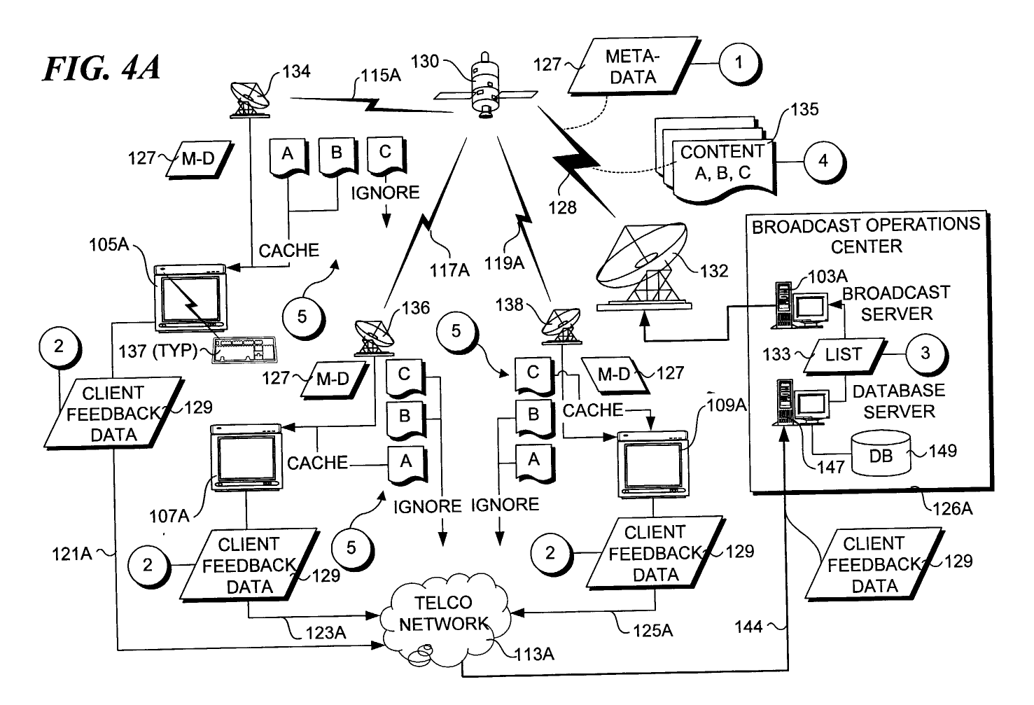

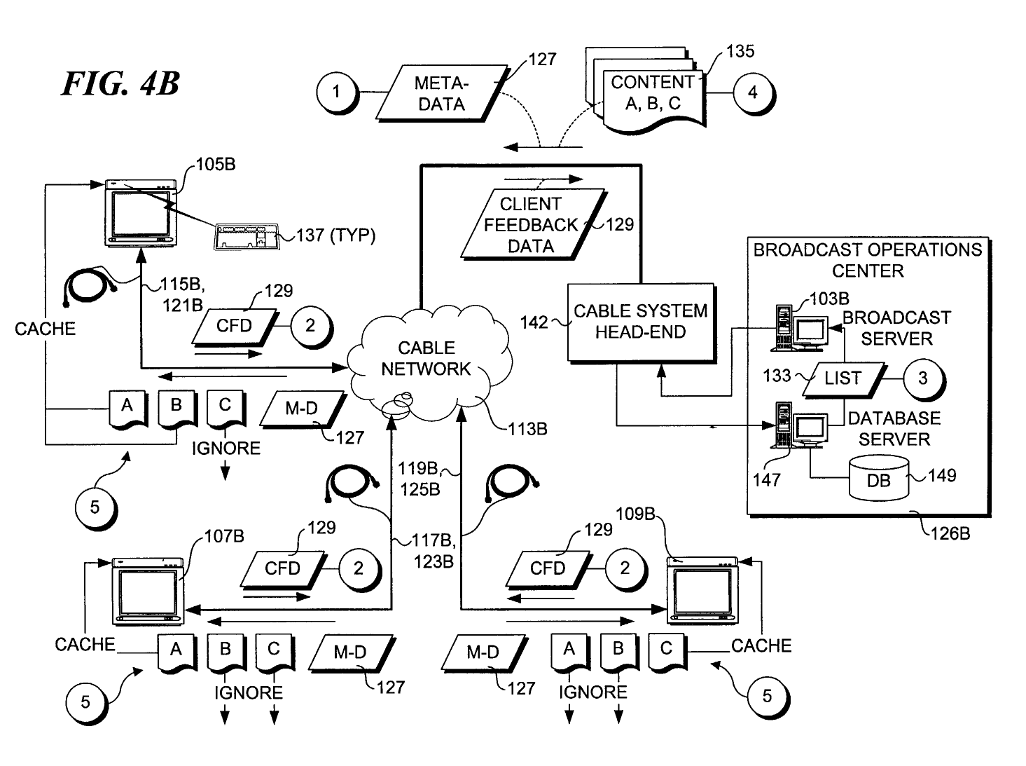

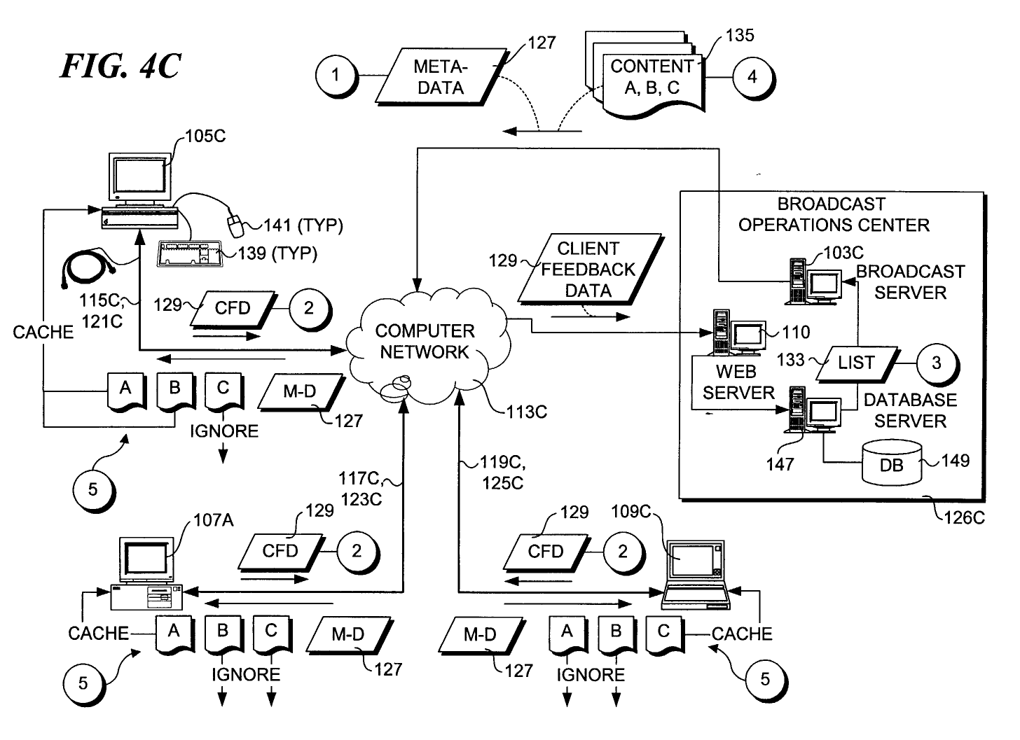

As illustrated by a block 300, in one embodiment, a meta-data broadcast schedule may be broadcast to the client systems over an appropriate broadcast link. For example, the client systems may comprise set-top boxes, and the broadcast links may comprise satellite television links, as illustrated in FIG. 4A. In this instance, a broadcast server 103A, operated by a broadcast operations center 126A sends an uplink signal 128 to a satellite 130 via a ground station 132. Satellite 130 then broadcasts the meta-data broadcast schedule to client systems 105A, 107A, and 109A via RF links 115A, 117A, and 119A, which are formed by RF transmission of data from the satellite to respective antennas 134, 136, and 138. Generally, satellite 130 functions as a multi-channel transponder, which sends out data streams using predetermined radio frequency bands, wherein each band corresponds to a respective channel. In one embodiment, a selected channel may be used to send this meta-data broadcast schedule data. In another embodiment, unused portions of a selected channel or multiplexed channels may be used to send the schedule data.

As discussed above, in addition to broadcasting content via satellite RF links, content may be broadcast over cable systems or computer networks. An example system for implementing the invention using a bi-directional cable system is shown in FIG. 4B. In this system, a broadcast server 103B, operated by a broadcast operations center 126B, submits broadcast data, such as the meta-data broadcast schedule, to a cable system head-end 142. The cable system head-end 142 provides the broadcasting functionality for the cable system, enabling data to be broadcast to set-top box client systems 105B, 107B, and 109B via a cable network 113B and respective bi-directional cable links 115B, 117B, and 119B.

An example system for implementing the invention wherein broadcast and client feedback data are transmitted via a computer network is shown in FIG. 4C. In this embodiment, a broadcast server 103C, operated by a broadcast operations center 126C, broadcasts data using a common network protocol, such as TCP/IP, over a computer network 113C to computer client systems 105C, 107C, and 109C via network links 115C, 117C, and 119C.

In one embodiment, the meta-data broadcast schedule indicates some point in the future when the actual meta-data of the present invention is going to be broadcast by the server. In one embodiment, the client systems use known ports such as for example, those used in the program and system information protocol (“PSIP”), DVB, service advertising protocol (“SAP”), or the like, to listen for upcoming service announcements from the server.

In one embodiment, each client 105x, 107x, and 109x (wherein 105“x” includes 105A, 105B, and 105C, etc.; see, e.g., FIGS. 4A-4C) contains a known scheduling service, which accepts requests to wake up, or be activated, at a specific time to receive the information broadcast by the server. This scheduling service enables the client to wake up at a specified time and select a specified service. For example, in one embodiment, this selection process can be accomplished by tuning to a specific frequency, such as for example, in an Advanced Television Systems Committee (“ATSC”), or a DVB transponder, or the like. In one embodiment, the selection process can be based on a set of data, such as for example, multi-cast Internet protocol (“IP”) addresses, which define a service.

In one embodiment, a client application registers with the client signaling system to receive signals from a specific content provider. The client signaling system maintains a table of applications associated with specific content providers. In one embodiment, information from the server is broadcast over known addresses such that each client can use the known address.

Returning to the flowchart illustrated in FIG. 3, process block 302 shows that the client receives the meta-data broadcast schedule from the server. In one embodiment, client systems 105x, 107x, and 109x capture and process this pre-broadcast information in order to determine when to wake-up and receive content, where to receive the content, and which content to receive. In one embodiment, when the meta-data broadcast schedule is received by the client, the registered application in the client is notified to receive the meta-data broadcast schedule.

In alternative embodiments, the meta-data itself is broadcast continuously as a stream that the client systems can tap into at any point in time. Accordingly, in these embodiments the operations performed by process blocks 300 and 302 are not required, as indicated by the dashed outlines for these blocks (indicating that they are optional). Preferably, when streaming embodiments are used, the meta-data stream will include a marker signal to indicate a start point for the current set of meta-data such that a client system only needs to listen for meta-data for a period during which two marker signals are received (guaranteeing that a complete set of the current meta-data has been received).

In a process block 304, meta-data 127 (see, e.g., FIGS. 4A-4C) is broadcast from the broadcast server to the client systems at the time specified in the meta-data broadcast schedule or using continuous streaming. In one embodiment, the clients wake-up at the pre-specified time indicated in the meta-data broadcast schedule to receive the meta-data from the server. Process block 306 shows that the client systems receive the broadcast of meta-data from the broadcast server. As will be discussed in greater detail below, the meta-data includes descriptions of a plurality of data files that will be broadcast or potentially broadcast later by the server system. At this point, the first task of providing meta-data to the client systems, as indicated by an encircled “1” in FIGS. 3 and 4A-4C is completed.

As provided by a process block 308, upon receiving meta-data 127, the client systems rate and/or rank the pieces of content corresponding to the meta-data to provide client demand feedback data (also referred to as “client feedback,” which may be comprised of “ranking feedback,”“rating feedback,” or a combination of the two), which may comprise a ranked list of the pieces of content or an absolute rating for each piece of content, back to the broadcast operations center indicating which pieces of content a user(s) of a given client system would like to have broadcast such that those pieces of content may be captured and cached on the client system for on-demand viewing by the user(s). There are three methods by which the client systems can produce the client demand feedback data. In one embodiment, the user(s) of the client systems may manually rate and/or rank the pieces of content, providing an explicit indication of what they would like to have broadcast. This process is provided by a process block 310 in FIG. 3 and described in further detail below. In an other embodiment, rating and/or ranking data is automatically generated by the client system in a process block 312, based, at least in part, on previous viewing preferences. This process is also described in further detail below. In a third embodiment, the client feedback comprises a combination of user- and client system-generated ratings and/or rankings.

As indicated by process block 314, the client system sends its client demand feedback data back to the server, which receives the data in a process block 316. The client demand feedback data is indicated as “CLIENT FEEDBACK DATA” 129 or “CFD” 129 in FIGS. 4A-4C, and the process of sending the client demand feedback data back to the broadcast operations center is indicated by an encircled “2” in FIGS. 3 and 4A-4C. In one embodiment, each client in the broadcast network sends client demand feedback data corresponding to all of the pieces of content that are described by meta-data 127 broadcast earlier from the server. Alternatively, each client sends all or part of a content rating/ranking table maintained on the client system, described in further detail below.

Depending on the broadcasting system used, there are several communication means that may be used to provide client demand feedback data back to the broadcast operations center. As discussed above with reference to FIG. 1A, each of the clients 105, 107, and 109 is provided with a “back channel” communications link, respectively indicated by links 121, 123, and 125. In the case of a conventional satellite television broadcast system, such as shown in FIG. 4A, there is only a uni-directional link between the satellite(s) and the receiving antennas. As a result, the communication link back to the broadcast operations center in these systems will typically involve some form of telecommunications (“Telco”) link, as indicated by links 121A, 123A, and 125A, from the clients, which are connected to broadcast operations center 126A via a Telco network 113A and a network link 144. It will be understood that future satellite broadcast systems may provide bi-directional communications links, whereby the client demand feedback data can be sent back to the broadcast operations center using a transceiver antenna. This type of communications technology may likely be similar to today's very small aperture terminal (“VSAT”) technology, which provides bi-directional satellite communication capabilities to users of VSAT systems.

In instances in which bi-directional cable broadcast systems are used, as shown in FIG. 4B, the same link 121B, 123B, and 125B for each of the given clients, respectively, may be used for both receiving broadcast data and for sending client demand feedback data back to the broadcast operations center 126B. Similarly, when a computer network broadcast infrastructure is used, such as depicted in FIG. 4C, the same links 121C, 123C, and 125C for each client, respectively, can be used for receiving broadcast data and sending client demand feedback data back to the broadcast operations center 126C. It should be noted that in computer networks, the actual “links” may be dynamic, wherein data packets are sent between end-points, such as between a client system and a server, using dynamic routing. However, for illustrative purposes, these links are depicted as solid lines in FIG. 4C. Depending on the particular communications infrastructure, the client systems may maintain a continuous connection to the broadcast operations center, or to a remote location linked to the broadcast operations center or broadcast source. In other embodiments, the client systems may initiate a connection to the broadcast operations center or the remote location to transmit client feedback.

Upon receiving client demand feedback data 129, the broadcast operations center creates or updates an ordered list 133 that ranks pieces of content based, at least in part, on the client demand feedback data, wherein the pieces of content with the highest demand are placed toward the top of the list. This process is indicated by process block 318 in FIG. 3, and by an encircled “3” in FIGS. 3 and 4A-4C. In general, the list is generated by aggregating the client demand feedback data, and optionally, applying server-side considerations such as whether a piece of content was recently broadcasted. Further details concerning how the list is generated are described below.

In one embodiment, the broadcast operations center then selects pieces of content based on the client demand feedback data. In one embodiment, data files corresponding to the pieces of content that are to be broadcast are determined based on ranking information provided by the client systems. In other embodiments, the pieces of content that are to be broadcast are determined based on rating information provided by the client systems, and in still other embodiments, the pieces of content that are to be broadcast are determined based on a combination of ranking and rating information provided by the client systems. As a result, only the most appropriate pieces of content for the customer base (e.g., users of the client systems) are broadcasted by the broadcast operations center. For instance, in one embodiment, only the pieces of content having the highest aggregate rankings are broadcast, while those pieces of content having the lowest aggregate rankings are not broadcast. For instance, in one embodiment, the highest ranked data files are broadcast before lower ranked data files. In another embodiment, the highest ranked data files are broadcast at a time assumed most appropriate to send highly ranked data files. For instance, assume an example where Thursday evenings during primetime is the most important time for a broadcaster to have the highest ratings for broadcast. In this example, a broadcast operations center in accordance with teachings of the present invention would broadcast a data file corresponding to the highest-ranked piece of content on Thursday evening during primetime. It is appreciated, of course, that this example is given for explanation purposes only and that a broadcast operations center may determine a broadcast schedule in other ways in response to demand feedback data received from the clients.

In one embodiment, the data files to broadcast and/or the broadcast schedule are determined dynamically by the broadcast operations center in response to the demand data received from the client(s) in accordance with teachings of the present invention. Therefore, in one embodiment, broadcast schedules can change over time depending on which pieces of content are available from the broadcast operations center and which content or data files are accessed and/or classified by the clients.

Once the content to be broadcast and the broadcast schedule are determined by the server, broadcast server 103 then broadcasts the content broadcast schedule in a process block 320. Process block 322 shows that the client then receives the data file broadcast schedule from the server. In other embodiments, there is no broadcasting of the content schedule, as indicated by the dashed outlines of blocks 320 and 322.

The next operation to be performed is to deliver content with the highest level of client demand (generally) to the clients. This is indicated by blocks 324 and 326 in FIG. 3, and is indicated by an encircled “4” in FIG. 3 and FIGS. 4A-4C. In one embodiment, opportunistic scheduling is used, wherein the next “most valuable” piece of content is broadcast on a continual basis. In another embodiment, batches of content are periodically broadcast. The broadcasting of one or more data files corresponding to exemplary pieces of content A, B, and C are shown in FIGS. 4A-4C, wherein the content is collectively identified by a set of content data files 135. Further details of each of these content-broadcasting embodiments are discussed below.

For embodiments in which content broadcast schedules have been previously sent, data files corresponding to each piece of content in the schedule are broadcast from the broadcast operations center at the scheduled time. In one embodiment, the clients wake-up at the pre-specified time indicated in the data file broadcast schedule to receive the data files from the server. In other embodiments, content is broadcast on a “real-time” basis, wherein prior schedule information has not been broadcast for that content. For purposes of this invention, “real-time” means that the content is sent shortly after it has been identified as the most-desired content (e.g., 1 hour or less). In these instances, broadcasting a schedule for such content is optional.

After broadcasting a piece of content, attribute values corresponding to that content are recalculated to re-rank the content in the ordered list. In general, this will return the piece of content to the bottom of the list, as provided by process block 328, since the demand for that piece of content by the client systems has effectively been satisfied by the preceding broadcast.

Upon receiving the content, in one embodiment the client selectively stores data files according to a content rating table stored on the client system as those data files are broadcast, as provided by process block 330. There are various mechanisms that may be used to determine when a particular piece of content is captured and cached (i.e., stored) on a given client system, and when other broadcasted content is ignored. These mechanisms may comprise a capture algorithm that considers a number of factors in evaluating whether or not to capture a particular piece of content. In one embodiment, demand feedback information, such as content rating and/or ranking data that is stored on the client is used to determine when a piece of content is to be captured and cached. The available storage space on a client system may also be considered. For example, if a client system has a content rating table indicating that a particular movie is rated a 10, that data file(s) corresponding to the movie will generally be captured and cached when those data file(s) are broadcast from the broadcast operations center.

In some instances, the determination of whether to capture and cache a new piece of content will depend on how the user rated and/or ranked the content that is presently stored on the client system. For example, is a client system is substantially full (i.e., the client system cannot store an entire data file or files corresponding to a new piece of content), and all of the pieces of content stored on the client system that have yet to be watched have a higher rating or ranking than the piece of content that is next to be broadcast, then that content will be ignored. Examples of content that are cached and ignored are depicted in FIGS. 4A-4C, wherein client systems 105x selectively cache content A and B, while ignoring content C, client systems 107x selectively cache content A, while ignoring content B and C, and client systems 109x selectively cache content C, while ignoring content A and B. The capture algorithm may, in an embodiment, be identical to the ranking algorithm or rating algorithm used to generate the client feedback.

In cases where a particular piece of content on a given client system has been accessed, in one embodiment it will generally be presumed that the user no longer demands to access that piece of content as much as he or she previously did when the rating and/or ranking for that piece of content was originally generated. For purposes of this disclosure, a user access may include a user interacting with, viewing, watching, listening to, reading, consuming, or the like, a data file. For instance, one example of a user accessing a data file may be the user watching a particular movie or listening to a particular song provided by one of the stored data files in the client system. Accordingly, when a user accesses a piece of content for viewing, the meta-data table and the content rating table entries corresponding to that piece of content are updated by the client system, as indicated by process block 332.

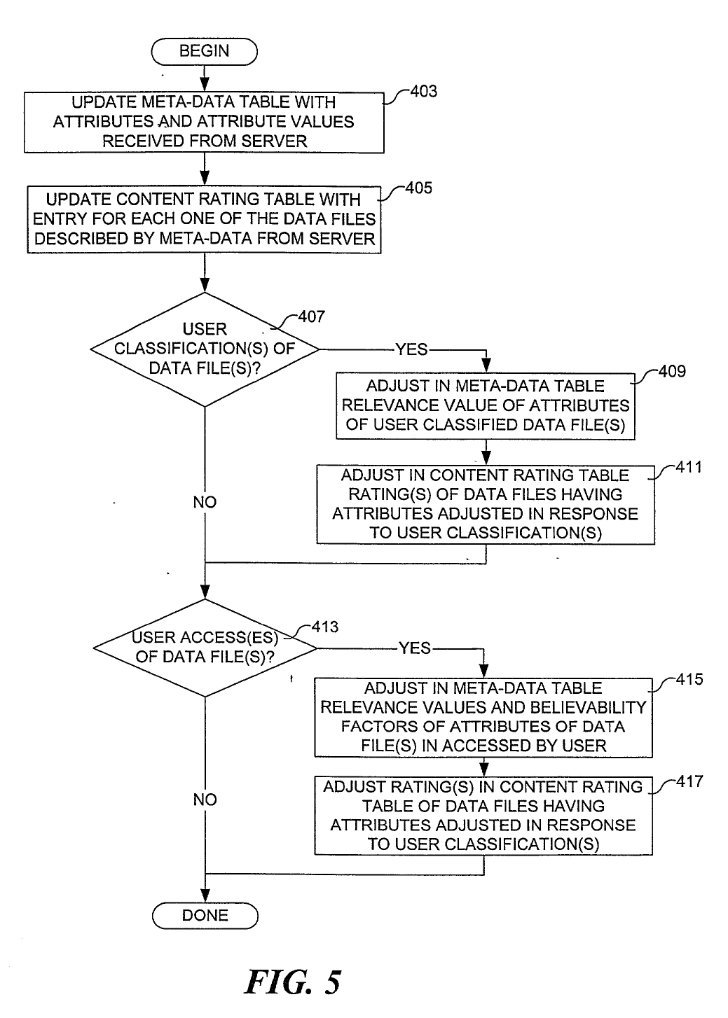

FIG. 5 is a more detailed flow diagram illustrating one embodiment of the flow of events in a client when processing meta-data 127 broadcasted from a server and updating and maintaining a meta-data table and a content rating table in accordance with the teachings of the present invention. In particular, process block 403 shows that a meta-data table is updated with attributes and attribute values included in the meta-data broadcasted from the server. Process block 405 shows that the content rating table is then updated with an entry for each one of the data files described by the meta-data broadcast from the server.

In one embodiment, it is assumed that a meta-data table, a content rating table and a plurality of data files already exist in the client system. In one embodiment, the meta-data table, content rating table and plurality of data files may be stored and maintained in the client system in the memory 205, the storage 211, or by accessing a local network, or the like with the machine 201, as illustrated in the embodiment shown in FIG. 2.

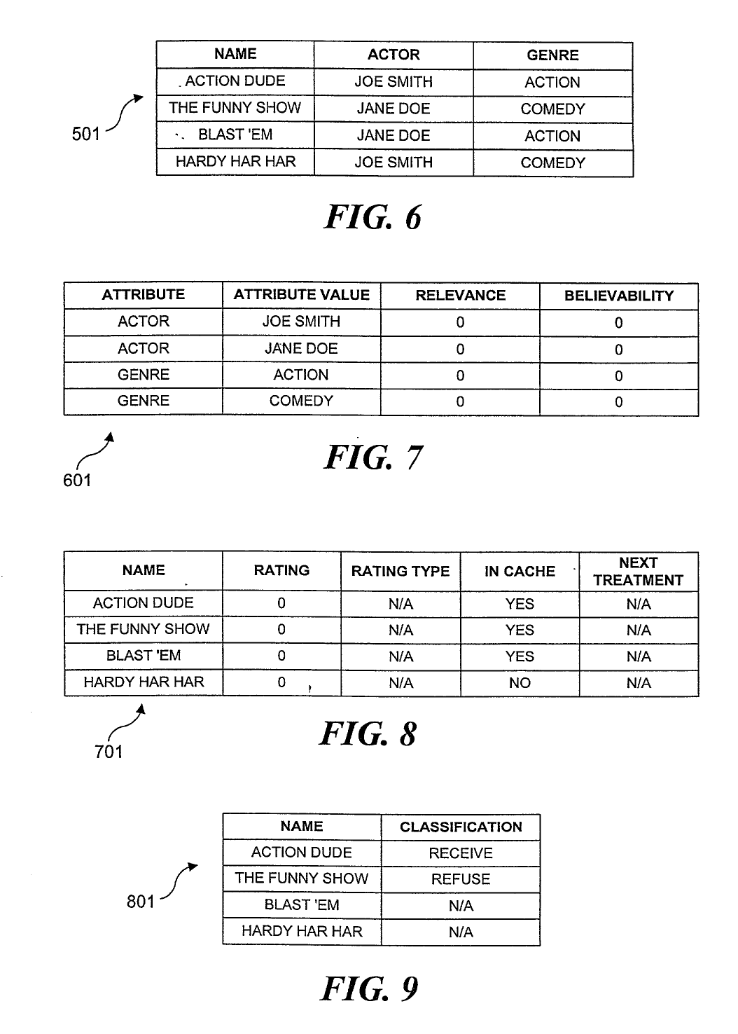

An example set of meta-data 501 corresponding to four pieces of content is depicted in FIG. 6. For explanation purposes, it is assumed that the data files corresponding to the four pieces of content are audio/video files such as for example, movies or TV programming. As mentioned above, the data files that are broadcast may comprise other types of files such as for example, but not limited to, audio, graphics, text, multi-media, or the like.

In the illustrated embodiment, meta-data 501 indicates that four movies, or more specifically, four data files corresponding to the four movies, are considered for broadcast later by the broadcast operations center. These movies include “Action Dude,” “The Funny Show,” “Blast 'Em,” and “Hardy Har Har.” In general, the meta-data will include attributes and attribute values that “describe” each piece of content the meta-data corresponds to. In one embodiment, the meta-data is delivered in a tabular format, wherein the attributes correspond to columns in the format, and the attribute values comprise the row data for the meta-data. For example, meta-data 501, includes three attribute columns, labeled “Name,” “Actor,” and “Genre.” It will be appreciated that other embodiments of the present invention may include different attributes as well as different attribute values. For instance, a non-exhaustive list of other attributes that may be used to describe movies may include “Director,” “Additional Actors,” “Year,” “Effects,” “Ending,” and the like. In one embodiment, for example, 40-50 different attributes may be provided to describe movies in accordance with the teachings of the present invention.

In the exemplary set of meta-data 501, “Action Dude” is an “action” movie featuring actor “Joe Smith.” “The Funny Show” is a “comedy” movie featuring actress “Jane Doe.” In addition, “Blast 'Em” is an “action” movie featuring actor “Jane Doe,” and “Hardy Har Har” is a “comedy” movie featuring “Joe Smith.”

To help illustrate the meta-data table aspect of the present invention, FIG. 7 is an example of one embodiment of meta-data table 601, which is updated and maintained locally by each client 105x, 107x, and 109x. In the illustrated embodiment, meta-data table 601 in FIG. 7 has been populated with the data included in meta-data 501, which was broadcasted earlier from server 103. In one embodiment, meta-data table 601 includes a list of attributes, attribute values, and corresponding relevance values and believability factors. In particular, meta-data table 601 includes attribute values “Joe Smith,” “Jane Doe,” “action,” and “comedy.” At this time, the relevance values and believability factors for attribute values “Joe Smith,” “Jane Doe,” “action,” and “comedy” are all zero in FIG. 7. As will be shown, in one embodiment, the relevance values and believability factors of the present invention will be updated and maintained as the user interacts with the client system.

In one embodiment, the relevance values in meta-data table 601 are indicators as to how relevant the associated attribute and attribute values are for predicting a particular user's behavior. For instance, the relevance value indicates how likely it is for the user to watch a particular movie because of this particular attribute value. In one embodiment, relevance values in meta-data table 601 are within a range of values such as for example, from −10 to 10. As will be discussed, the relevance value may be increased if, for example, the user watches a particular movie having that particular attribute value. Conversely, the relevance value may be decreased if the user, for example, does not watch a particular movie, or if the user explicitly indicates that he or she does not want to watch a particular movie having that particular attribute value.

In one embodiment, the believability factors in meta-data table 601 are weighting factors to be applied to specific attribute and attribute value pairs when ranking/rating, or predicting whether a user will actually access a particular data file having that particular attribute value. In one embodiment, believability factors in meta-data table 601 are within a range of values such as for example, from −10 to 10. In one embodiment, the believability factors may be increased, for example, when an attribute value accurately predicts a data file in which the user is interested. Conversely, the believability factors may be decreased when a user is interested in the data file, even though the particular attribute value indicates otherwise.

In one embodiment, meta-data table 601 entries are constructed from the aggregation of all meta-data 501 associated with potential content or data files to be broadcast from server 103. In one embodiment, entries in meta-data table 601 are updated based on explicit user requests. In addition, updates to meta-data table 601 may also be implicitly based on whether a user accesses specific data files having particular attribute values, independent of whether the user explicitly classifies a particular movie.

To help illustrate the content rating table aspect of the present invention, FIG. 8 illustrates an example of one embodiment of a content rating table 701, which, in one embodiment, is updated and maintained locally by each client 105x, 107x, and 109x. In the illustrated embodiment, content rating table 701 includes a list of the data files described in meta-data 501 as well as any additional data files that are currently stored or cached locally by the client.

In one embodiment, data files corresponding to previously cached pieces of content may be stored locally by the client in, for example, the memory 205, the storage 211, or in a locally accessible network by the machine 201 of FIG. 2. For purposes of this disclosure, data files being stored locally by the client may also be interpreted to include a data file stored “locally” by the client in a known network storage configuration, separate from the server. For purposes of this disclosure, the data file being stored or cached locally by the client is to be interpreted as the data file being stored for later access, retrieval, or consumption. In one embodiment, the local cache of the present invention is considered to be a first level cache. Thus, the local cache of the present invention is sized accordingly to increase the possibility of a single hit.

Referring back to the continuing example of data files representing audio/video files, a movie is stored locally by the client. After a user watches the movie, the storage space occupied by the movie is generally considered to be available for storage of another movie to be broadcast sometime later. Thus, it is appreciated that the local cache of the client system is modeled as the single use system, e.g., fire and forget, in accordance with teachings of the present invention. In one embodiment, it is assumed that when a user accesses a data file, it is not likely that the user will want to access that same data file again. If a user has not watched a particular movie, the storage space occupied by that movie is generally considered not to be available for storage of another movie. However, if there is no additional storage space available, and a higher ranked and/or rated movie is to be broadcast, the lower ranked and/or rated unwatched movie is replaced by the higher ranked and/or rated movie in accordance with the teachings of the present invention. For example, in one embodiment, the user of a client system may select a switch that enables stored data files to automatically be replaced by one or more data files corresponding to higher rated or ranked pieces of content when those data files are broadcast. Conversely, the user may desire to manually manage which data files on his or her client system.

Referring back to the embodiment of content rating table 701 shown in FIG. 8, each movie also has an associated rating, a rating type indicator, an in cache indicator, and a next treatment indicator. In one embodiment, the rating indicates a value for the associated piece of content. The rating value, in one embodiment, may either be explicitly input by a user, or implicitly generated by the client system by processing meta-data associated with that particular data file. In one embodiment, a relatively high rating value predicts that the particular data file may be of interest to the user. Conversely, in one embodiment, a relatively low rating value predicts that the particular data file is unlikely to be of interest to the user.

In one embodiment, the rating type indicator indicates whether the rating value of this particular data file was a result of explicit input from the user, or if the rating value was implicitly generated by the client system. Thus, in one embodiment, the rating type indicator of content rating table 701 may be explicit, implicit, or not applicable (“N/A”) if the data file or movie has not yet been rated. In one embodiment, if a data file has been explicitly classified by a user, then the rating values of attribute values of the data file are no longer updated implicitly by the client system. However, if a data file has not yet been classified, or has only been implicitly rated by the client system, the rating of the attribute values of the data file may be further updated or adjusted by the client system.

In one embodiment, the in cache indicator indicates whether that particular data file is currently stored or cached locally by the client. In the embodiment illustrated in FIG. 8, the movies “Action Dude,” “The Funny Show,” and “Blast 'Em” already exist in the local storage of the client system. Conversely, the movie “Hardy Har Har” has not been stored in the local storage of the client system.

In one embodiment, the next treatment indicator is used to track future actions to be taken for the particular data file. For example, if a movie has already been watched by the user, the next treatment indicator would indicate “replace” to indicate that the storage space occupied by that particular movie is available for storage of another movie. In one embodiment, if the movie has not yet been watched by the user, the next treatment indicator would indicate “keep.” In one embodiment, if the movie has not yet been stored locally by the client, and if the rating value predicts that this particular movie may be of interest to the user, then the next treatment indicator would indicate “capture.” In one embodiment, if the movie has not yet been broadcast by the server, and the rating predicts that this movie is unlikely to be of interest to the user, then the next treatment indicator would indicate “ignore.”

As discussed above, users may provide explicit inputs that are used to determine what content should be cached, and what content should be ignored; these inputs are termed “classifications.” In one embodiment, as illustrated in FIG. 9, a user can explicitly “classify” each piece of content to indicate whether the user would like that piece of content cached or not cached by entering or selecting “Receive” or “Refuse,” respectively. In the example illustrated in FIG. 9, the user has indicated that he or she would like to cache the movie “Action Dude” by classifying that movie with a “Receive” classification, while the user has expressed that he or she does not have any interest in the movie “The Funny Show” by classifying that movie with a “Refuse” classification. In this example, the user has not provided any information or classification regarding any of the remaining movies.

Returning to the flowchart illustrated in FIG. 5, if the user has classified any of the data files, the answer to decision block 407 is YES, and the relevance values of the particular attributes of the classified pieces of content are updated in meta-data table 601 in process block 409. Process block 411 shows that the ratings of data files having attribute values with relevance values that were adjusted in response to the user classification(s) are also adjusted. In one embodiment, if the user has not classified any data files, process blocks 409 and 411 are skipped.

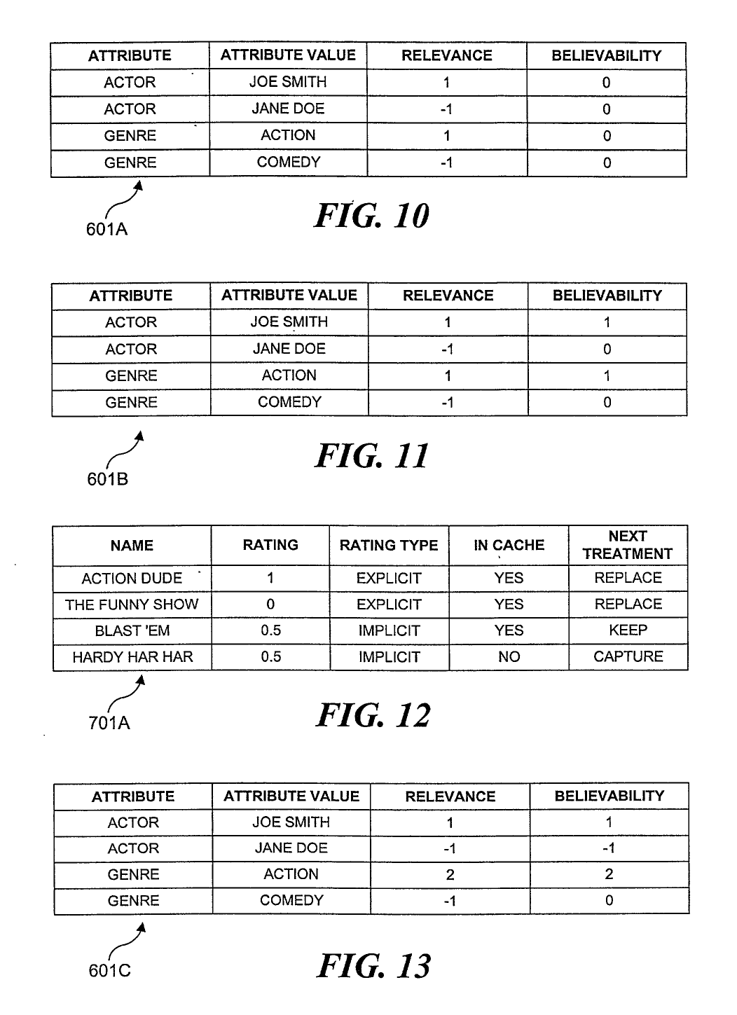

To illustrate an example of when a user classifies data files, FIG. 10 shows a meta-data table 601A after it has been updated or adjusted in response to a user classification. As discussed above the user indicated that he or she was interested in the movie “Action Dude.” As described by meta-data 501 “Action Dude” features actor “Joe Smith” and is an “action” movie. Thus, referring to meta-data table 601A in FIG. 10, the relevance values for attribute values “Joe Smith” and “action” are adjusted to reflect that the user explicitly expressed an interest in “Action Dude.” In one embodiment, the relevance values are increased to reflect that the user was interested. As will be discussed, in one embodiment, the believability factors associated with each attribute value are not updated until there is a user access of the data file having that particular attribute value.

Continuing with the example of FIG. 9, the user indicated that he or she was not interested in the movie “The Funny Show.” Meta-data 501 shows that “The Funny Show” features actress “Jane Doe” and is a “comedy” movie. Thus, referring back to meta-data table 601A in FIG. 10, the relevance values for attribute values “Jane Doe” and “comedy” are adjusted to reflect that the user explicitly expressed that he or she was not interested in “The Funny Show.” In one embodiment, the relevance values are decremented to reflect that the user was not interested.

Continuing with the example of FIG. 9, the user did not provide any information regarding the movies “Blast 'Em” and “Hardy Har Har.” Accordingly, the relevance values of the attribute values associated with “Blast 'Em” and “Hardy Har Har” are not updated in meta-data table 601A.

As will be discussed, in one embodiment, updates to the ratings in content rating table 701, as described in process block 411, are related to the relevance values and believability factors of the attribute values listed in meta-data table 601. A detailed description of the processing that occurs in process block 411 is substantially the same as the processing that occurs in process block 417 below.

Referring back to FIG. 5 once again, if the user accesses any of the data files, e.g. the user watches a movie, as determined in decision block 413, process block 415 shows that the relevance values and the believability factors of the particular attributes of the user accessed data files are updated in meta-data table 601. The logic then flows to process block 417, which shows that the ratings of data files having attribute values with relevance values that were adjusted in response to the user access(es) are also adjusted. If the user has not accessed any data files, process blocks 415 and 417 are skipped.

To illustrate an example of a user accessing data files, assume that the user watches the movie “Action Dude.” Meta-data 501 shows that “Action Dude” features actor “Joe Smith” and is an “action” movie. In one embodiment, each time a user accesses or interacts with a particular data file, the believability factor of the attribute values of that film are adjusted or updated. In one embodiment, for attribute values having relevance values greater than zero, the believability factor for that attribute value is increased, since that attribute value accurately served as a predictor for a data file that the user would access. In one embodiment, for attribute values having relevance values less than zero, the believability factor for that attribute value is decreased, since that attribute value did not accurately serve as a predictor for a data file that the user would access. Therefore, FIG. 11 shows a meta-data table 601B in which the “Believeability” column has been updated or adjusted in response to the user access of “Action Dude.” In this example, the believability factors of “Joe Smith” and “action” are increased since the relvance values for these attribute values were greater than zero.

In one embodiment, the relevance values associated with implicitly rated data files are also increased in meta-data table 601B in response to a user access. However, in the example shown in meta-data table 601B of FIG. 11, “Action Dude” was explicitly classified by the user. In one embodiment, the relevance values are not updated in meta-data table 601 in response to a user access of data files explicitly classified by the user.

FIG. 12 shows content rating table 701A corresponding to content rating table 701 after it has been updated in process block 417 in response to the user access of “Action Dude.” As discussed above, content rating table 701 is also updated as described in process block 411 in accordance with the teachings of the present invention. As shown in content rating table 701A, “Action Dude” has a rating value of 1. The rating type of “Action Dude” is “explicit” because the user explicitly classified “Action Dude,” as described above in connection with FIG. 9. The in cache indicator indicates that “Action Dude” is presently locally stored by the client system. The next treatment indicator indicates “replace” because the user has already watched “Action Dude.”

In one embodiment, the rating values in content rating table 701 are determined as follows. Meta-data 501 shows that “Action Dude” has the attribute values “Joe Smith” and “action.” Meta-data table 601B shows that “Joe Smith” has a relevance value of 1 and a believability factor of 1. Meta-data table 601B also shows that “action” has a relevance value of 1 and a believability factor of 1. In one embodiment, the rating value of a particular data file is determined based on a consideration of all of the relevance values combined with their respective believability factors for all of the attribute values of the data file. For instance, in one embodiment, the rating value for a data file is equal to the average of all of the products of each relevance value and corresponding believability factor for the attribute values of the data file.

To illustrate, referring to “Action Dude” in content rating table 701A, the product of the relevance value and believability factor of “Joe Smith” is 1*1, which equals 1. The product of the relevance value and believability factor of “action” is 1*1, which equals 1. The average of the products, 1 and 1, is 1. Therefore, the rating of “Action Dude” in content rating table 701A is 1.

Similarly, with regard to “Blast 'Em” in content rating table 701, “Blast 'Em” has the attribute values “Jane Doe” and “action.” The relevance value and believability factors for “Jane Doe” in meta-data table 601B are −1 and 0, respectively. The relevance value and believability factors for “action” in meta-data table 601B are 1 and 1, respectively. Thus, the rating of“Blast 'Em” in content rating table 701A is the average of −1*0 and 1*1, which equals 0.5. The ratings for “The Funny Show” and “Hardy Har Har” in content rating table 701A, in the example shown in FIG. 12, are determined in a similar fashion in one embodiment of the present invention.

It should be noted that since the user classified the movies “Action Dude” and “The Funny Show” above in FIG. 9, these movies have an explicit rating type as shown in content rating table 701A. Since the user did not classify the movies “Blast 'Em” and “Hardy Har Har,” these movies have an implicit rating in content rating table 701A.

It will be appreciated that the discussion above provides one example of how the rating values in content rating table 701 are determined in accordance with the teachings of the present invention. It is noted that ratings values may be determined in other ways in accordance with the teachings of the invention, which consider the relevance values and believability factors for each of the attribute values of a piece of content.

In one embodiment, the entry for the “next treatment” in content rating table 701A is determined in part by the rating and in cache values for the particular piece of content. For example, assume in one embodiment that a rating of greater than zero indicates that the user is predicted to have at least some interest in that particular movie. Therefore, the movies “Blast 'Em” and “Hardy Har Har” may be of some interest to the user. Thus, the next treatment indicates that the movie “Blast 'Em” will be kept in storage, and the movie “Hardy Har Har” will be captured when it is later broadcast by the server. As mentioned above, the movie “Action Dude” is marked for replacement in the next treatment field because it has already been watched by the user.

In one embodiment, future interactions by a user with the client system results in similar processing as described above. For instance, assume that the user now watches the movie “Blast 'Em.” In this particular example, the user did not classify the movie “Blast 'Em” before watching the movie. In one embodiment, both of the relevance values and believability factors are updated for the attribute values of unclassified data files that are accessed, as shown in meta-data table 601C of FIG. 13. Recall from meta-data 501 that the movie “Blast 'Em” features “Jane Doe” and is an “action” movie. As shown in FIG. 11, the relevance value of “Jane Doe” was less than zero, or −1, prior to the user watching “Blast 'Em.” Nevertheless, in this example, the user watched “Blast 'Em,” despite the fact that it featured actress “Jane Doe.” Accordingly, the believability factor of the “Jane Doe” attribute value is adjusted downward since this particular attribute value now appears less likely or relevant when predicting a user's viewing habits. In one embodiment, since the relevance value is already less than zero, the believability factor is not adjusted further downward. However, the relevance value and believability factor for the attribute value “action” are adjusted upwards since “action” had a relevance value of greater than zero prior to the user watching “Blast 'Em.” Thus, in this example, the relevance value is adjusted upwards from 1 to 2, and the believability factor is also adjusted upwards from 1 to 2. Therefore, the content rating table 601C now predicts that “action” movies are movies that the user is more likely to watch.

In one embodiment, each time the user interacts with the client system, the meta-data table 601 and the content rating table 701 are updated. Updates to the meta-data table 601 and the content rating table 701 are performed when the user accesses data files, as well as when the user explicitly classifies data files. It is appreciated that the user is not required to classify data files explicitly in order for the meta-data table 601, and content rating table 701, to be updated in accordance with the teachings of the present invention. As a result, the content rating table over time will more accurately predict data files in which the user is interested.

In one embodiment, the pieces of content in which the user is predicted implicitly to be most interested, as well as pieces of content in which the user explicitly classified an interest, will be the pieces of content that are cached locally on the client system. In effect, the pieces of content that the user is most likely to want to watch are automatically stored locally, and therefore available “on demand,” in accordance with teachings of the present invention without the user having to explicitly request these pieces of content in advance or explicitly specify criteria used to identify the pieces of content.

As can be appreciated, by storing the data files locally on each client, broadcast bandwidth is utilized more efficiently in accordance with teachings of the present invention. Indeed, when a user watches a movie from the local storage of the client, no additional broadcast bandwidth is utilized. In addition, it will also be appreciated that a substantial amount of the processing performed in a system according to the teachings of the present invention is performed on each of the client systems when updating their respective meta-data tables and content rating tables. This distributed processing of the present invention enables the presently disclosed broadcast system to scale across a very large number of users since the incremental cost to the server for each additional client is zero.

As discussed above, the client systems may send feedback information that is automatically generated based on past viewing habits, manually generated by the user(s) of the client systems, or a combination of automatic and manual generation. For example, as discussed above with reference to FIG. 11, the rating values for each piece of content were automatically generated.

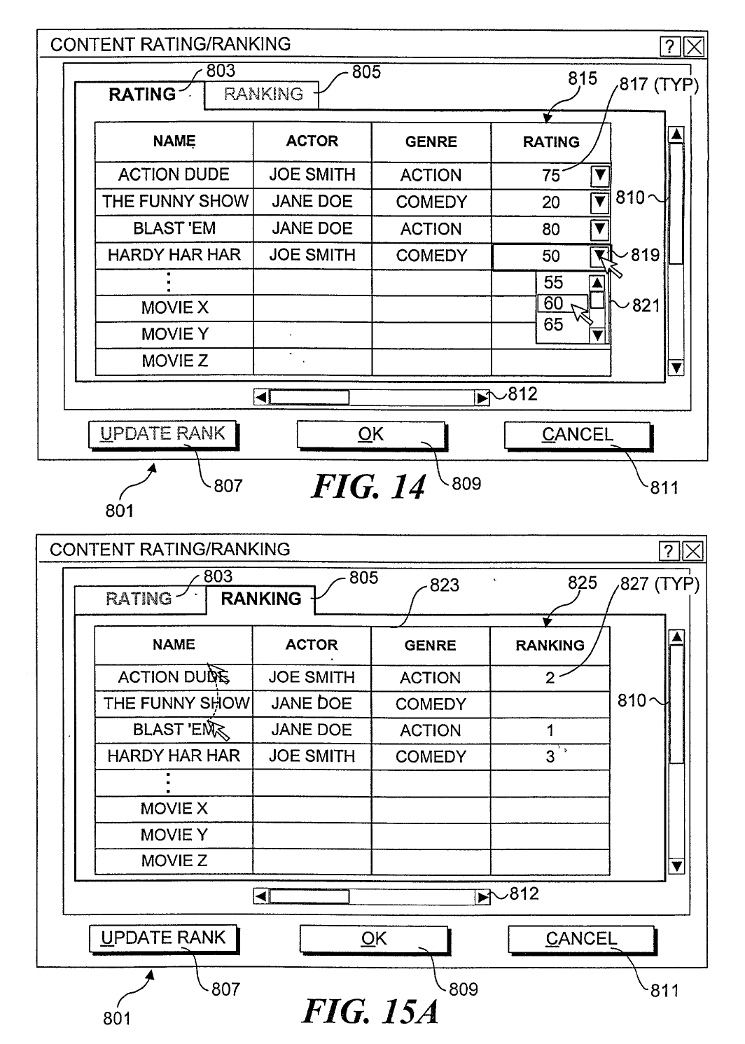

An example user-interface 801 that enables users to rate and/or rank pieces of content that are considered for broadcasting is depicted in FIG. 14. User-interface 801 includes a rating tab 803 and a ranking tab 805, an “UPDATE RANK” button 807, an “OK” button 809, and a “CANCEL” button 811. The user-interface may also include a vertical scroll bar 810 and a horizontal scroll bar 812. Rating tab 803 includes a user rating table 813 that will typically include a set of columns pertaining to the meta-data that is sent, along with a rating column 815 in which the user may enter a rating value 817 for each piece of content. In the illustrated embodiment, rating table 813 includes meta-data 501. The rating table may include additional columns (not shown) corresponding to other meta-data attributes, such as director, additional actors, a plot narrative, or the like, as mentioned previously. These additional columns may be accessed by activating horizontal scroll bar 812, wherein the user interface is designed in one embodiment such that the rating column 815 is always visible to the user, regardless of which attribute columns are currently displayed.

In one embodiment, a user may enter a rating value 817 from 0-100 for selected pieces of content, wherein a low rating value indicates the user is not interested in receiving data files corresponding to a piece of content, and a high rating value indicates that the user is interested in the piece of content. In one embodiment, the user may enter rating values 817 by using a keyboard, keypad, or the like. For example, as discussed above, the client systems may comprise set-top boxes, which are generally accessed through use of a remote control or a remote keyboard, such as depicted by a remote keyboard 137 in FIGS. 4A and 4B. When a client system comprises a desktop computer, the computer's keyboard may be used to enter the data, as depicted by a keyboard 139 in FIG. 4C. Optionally, a dropdown control 819 may be provided for each row, wherein the user can select a rating value from a dropdown list 821 through use of an input device such as a set-top box cursor device (not shown) for set-top box client systems, or a mouse or similar input device for computer client systems, such as depicted by a mouse 141 in FIG. 4C.

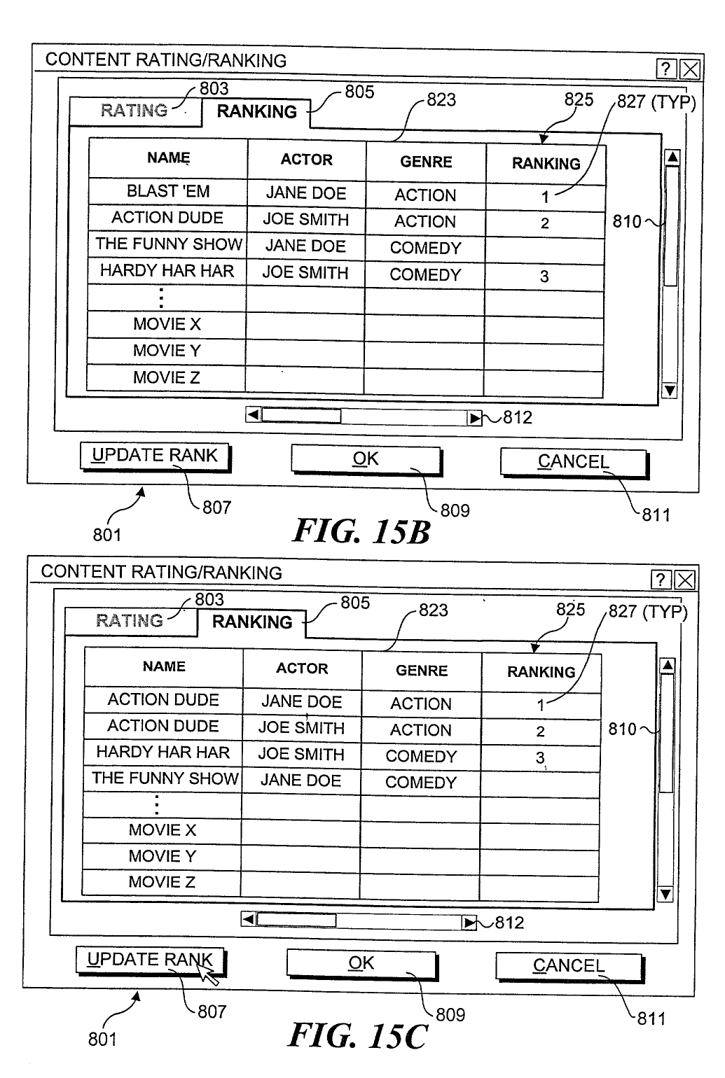

Various user-interface views of ranking tab 805 are shown in FIGS. 15A-15C. Ranking tab 805 includes a ranking table 823 that includes columns that are similar to the columns in ratings table 813, except rating column 815 is replaced with a ranking column 825. Users may enter ranking values 827 in ranking column 825 to reflect the user's relative ranking of all or a portion of the pieces of content corresponding to a most-recent set of meta-data received by a client system. For instance, a user may enter ranking values of 1, 2, 3, etc., as depicted in FIG. 15A. Optionally, a user may drag and drop selected pieces of content to new positions, as depicted by a cursor drag and drop movement 829 in FIG. 15A, wherein the results of this action are reflected in FIG. 15B. As illustrated in FIG. 15C, in one embodiment, a user can activate update rank button 807 to cause the pieces of content in ranking table 805 to be reordered in view of their rankings, wherein the highest-ranked pieces of content appear at the top of the table.

After the content ratings and/or rankings have been manually entered and/or automatically generated, a set of client demand feedback corresponding to a present set of meta-data is sent back to the broadcast operations center. In general, the client demand feedback data can be sent back on a periodic basis as a batch, asynchronously, or, in the case of rating feedback, in “real-time” as each piece of content is rated explicitly or implicitly. For example, in embodiments in which the meta-data is broadcast via a schedule, a similar schedule that is offset from the meta-data broadcast schedule may be used to cause the client demand feedback data to be sent back to the broadcast operations center in a substantially “batch” mode. Alternatively, upon expiration of a predetermined time period, or upon a detection that a user has rated or ranked pieces of content corresponding to the current set of meta-data, the client demand feedback data may be sent back to the broadcast operations center. This is termed “asynchronous” because the client demand feedback data is sent in a manner that does not adhere to a schedule, and is substantially random.

The client demand feedback data reflects a desirability for a given client to receive pieces of content corresponding to the current set of meta-data. This feedback demand data may comprise manual ratings, manual rankings, automatically generated ratings, automatically generated rankings, or a combination of these feedback demand attribute values. In effect, a ranking algorithm or a rating algorithm, which may consider user input as well as other features such as those discussed above in conjunction with FIGS. 5-13, is performed or implemented by a processor to generate the ranking feedback or rating feedback in an embodiment. For example, in one embodiment, the client demand feedback data only includes user-generated ratings and/or rankings, wherein there is no feedback data for pieces of content that have not been rated and/or ranked by a user of a client system. In one embodiment, ratings for any pieces of content that are not user-generated are automatically generated using the process described above with reference to the flowchart of FIG. 5. In yet another embodiment, a combination of automatically and manually generated client feedback is used, but the feedback data corresponds to only a portion of the pieces of content in the current set of meta-data.

In instances in which a combination of manually and automatically-generated demand feedback data is used, a scaling/offset algorithm may be applied to provide a commonly-weighted set of demand feedback data that more accurately reflects the pieces of content a user desires to receive. For example, in the foregoing examples the automatically-generated ratings have a scale from −10 to 10, while the user-generated ratings have a scale from 0-100, for ease of use by the viewer. Either of the two scales could be adjusted so as to produce a set of ratings values using a single scale. For example, each value in the −10 to 10 scale could be multiplied by 5 and then have 50 added to it to produce an equivalent value that fits the 0-100 scale. In other instances, it may be desired to weight a user's explicit ratings higher than the automatically-generated ratings. Thus, in the foregoing example, a −10 to 10 automatic scale value could be scaled by a scale factor, an offset that would result in a rating value of less than 100 for a maximal automatically-generated value of 10.

In addition to manually ranking pieces of content, other pieces of content may be automatically ranked by first automatically generating a rating value for those pieces of content, and then producing a ranking based on these rating values. In one embodiment, when the manually and automatically-ranked values are combined, the highest ranked automatically-ranked piece of content is ranked below the lowest ranked manually-ranked piece of content. In one embodiment, there is a gap between the lowest-ranked manually-ranked piece of content and the highest ranked automatically-ranked piece of content. For example, suppose that a particular set of meta-data corresponds to forty (40) pieces of content that are considered for broadcast by the broadcast operations center, and a user ranks selected pieces of content from 1-9. The remaining 31 pieces of content could then be ranked from 10-40, 15-45, 20-50, etc. This would provide a weighting factor that favors user rankings more so than automatically-generated rankings.

Another consideration that may be used in weighting the client demand feedback data is the revenue potential that may be generated by having the client system cache a particular piece of content. For example, pay-per-view content may have a weighting factor that increases the demand “value” for such content in the client demand feedback data. In one embodiment, the revenue potential may be used in a tie-breaker when rankings are used.

Once the demand feedback data is generated at the client, the client needs to send this data back to the broadcast operations center. As discussed above, the particular “back-channel” communications link that is used will depend on the broadcast and feedback system infrastructure. Once the client demand feedback data is transmitted from the client, it is received by a “front-end” at the broadcast operations center where it is passed to a database server 147 that operates a database 149 in which the client demand feedback data is stored and processed. A typical front-end may comprise one or more network servers, which have application code that is used to receive the client feedback data and route it to database server 147. In addition, various switches and firewalls may sit between the front-end and the database server 147. In other implementations, database server 147 may be used directly for these front-end processes. For clarity, the various components used in the front-end are not shown in the figures herein.

Database server 147 maintains an ordered list 133 of the pieces of content corresponding to a current set of meta-data, wherein the pieces of content are placed in the list 133 based on their relative demand as determined from the client demand feedback data provided by the clients, and/or other considerations, such as available broadcast bandwidth, contractual requirement with various broadcasters, etc. In one embodiment, ratings are used to determine the ordered list 133, wherein the pieces of content are ordered based on their average ratings. In another embodiment, the rankings are used, and the ordered list 133 is determined based on a predetermined ranking formula. For example, a ranking formula embodied by the following description may be utilized. For a current set of meta-data, a range of rankings is determined. For example, if the current set of meta-data contains content descriptors relating to fifty (50) pieces of content and no ranking offset is used, client demand feedback data pertaining to those pieces of content will have ranking values from 1 to 50 (it is noted that while some pieces of content will not be ranked by a portion of the client systems, all pieces of content will be ranked by at least some client systems). Each ranking value will then be recalculated based on its deviation from the maximum value plus 1. For example, in the present example, the deviation will be taken from 51 whereby an original ranking of 1 will now have value of 50, while an original ranking of 50 will now have a value of 1. The recalculated values are simply summed, with the pieces of content having the highest sums placed at the top of the ordered list 133. This scheme enables more weight to be added to content that is ranked versus content that has not been ranked. For example, it is generally believed that a user will be more interested in ranking content that the user has an interest in, as opposed to content in which the user is not interested. Accordingly, pieces of content that have been rated and/or ranked by users will be considered to be in higher demand than pieces of content that have not been rated and/or ranked by users.

In general, database server 147 will comprise a computer server running a relational database management system (“RDBMS”) server software package, such as the SQL-based RDBMS server products produced by Oracle (e.g., Oracle 8i enterprise edition), Microsoft (SQL Server 7), Informix, and Sybase. The foregoing database server products are designed to handle large transaction throughputs using multiple connects.

In one embodiment, as each set of client feedback data is received by database server 147, the data is parsed, individual records corresponding to each piece of content having demand feedback data is entered in database 149, and the ordered list 133 is automatically reordered based on the new set of data. For example, client demand feedback data may comprise a comma delimited list or a set of extensible markup language (“XML”) data that is received by database server 147, converted into individual “rows,” and inserted into a “demand data” table in database 149. An “after insert” trigger could then be used to automatically run a query that reorders the ordered list 133 based on existing data in the “demand data” table. As a result, the ordered list 133 would be updated in response to each set of client demand feedback data that is received.

As described above, various data processing functions such as the resealing and offsetting of rating and/or ranking data, weighting the data, etc., were performed on the client systems. In an optional embodiment, these functions may be performed by database server 147. For example, the client feedback data could be sent to correspond to a tabular format, wherein additional columns could be used to identify how the data values were generated.

In addition to the rating and ranking values, each set of demand feedback data may include a meta-data set identifier that is used by database 149 to organize its data in a manner that matches each ordered list of content it generates with a corresponding set of meta-data that was broadcast to the clients. For example, each set of meta-data that is broadcast may have a meta-data ID comprising a timestamp or sequential number to uniquely identify the set of meta-data, wherein the meta-data ID is sent back with the client feedback.

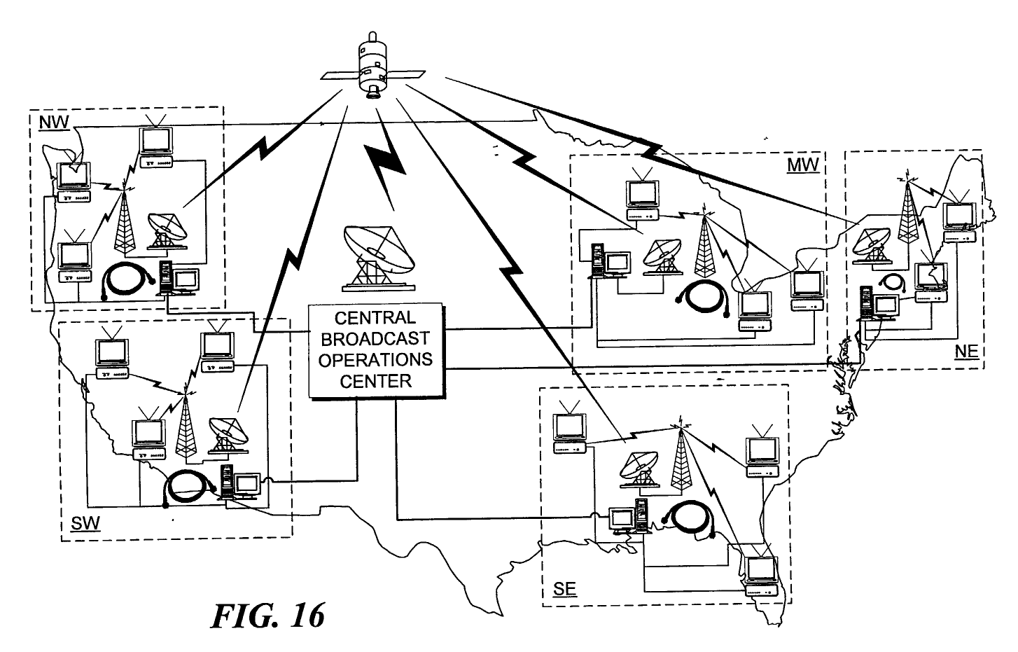

In other embodiments, different (or the same) sets of meta-data may be broadcast to different sets of clients, which may be delineated by geographical location or broadcast provider. For example, FIG. 16 illustrates how a central broadcast operations center may broadcast meta-data based, at least in part, on the geographical location of the client system that is intended to receive the broadcast. Client feedback may, in one embodiment, be sent back to the broadcast operations center individually by each client system. In other embodiments, the client feedback may be sent to a remote location that is linked to the broadcast operations center or broadcast source.

As discussed above, automatically-generated ratings and/or rankings may be derived from a combination of a user's previous viewing habits (e.g., in response to pieces of content that have been or are currently cached on the client system), and previous ratings and classification provided by the user and through use of the relevance and believability factors. In some instances, data pertaining to a user's previous viewing habits may not be used due to privacy concerns. However, in order to overcome most privacy concerns, in one embodiment the client demand feedback data is sent back to the broadcast operations center through a mechanism that prevents identification of the client and/or user from which the client feedback was sent. For example, this “anonymous” client schema could be implemented through an encryption process wherein the client demand feedback data is encrypted and must pass through a decryption service having a private key that is not accessible to the broadcast operations center or any other third party.

While the invention is described and illustrated here in the context of a limited number of embodiments, the invention may be embodied in many forms without departing from the spirit of the essential characteristics of the invention. The illustrated and described embodiments, including what is described in the abstract of the disclosure, are therefore to be considered in all respects as illustrative and not restrictive. The scope of the invention is indicated by the appended claims rather than by the foregoing description, and all changes which come within the meaning and range of equivalency of the claims are intended to be embraced therein.

What is claimed is:

1. A method, comprising:
receiving broadcast communications including content descriptors via a first communications link from a broadcast source, the content descriptors including descriptions of a plurality of corresponding content pieces;
performing a rating algorithm to rate at least a portion of the plurality of content pieces to generate a rating feedback; and
transmitting the rating feedback via a second communications link to a remote location.

2. The method of claim 1, wherein the first communications link and the second communication link comprise a common transmission platform.

3. The method of claim 1, wherein the first communications link and the second communications link comprise separate transmission platforms.

4. The method of claim 1, wherein the rating feedback comprises a plurality of rated content pieces, and wherein transmitting the rating feedback comprises periodically transmitting a batch of the rating feedback to the remote location, the remote location being linked to the broadcast source.

5. The method of claim 1, wherein the rating feedback comprises a single rated content piece, and wherein transmitting the rating feedback comprises transmitting the rating feedback to the remote location in real-time.

6. The method of claim 1, wherein the second communications link comprises a continuous connection to the remote location, the remote location being linked to the broadcast source.

7. The method of claim 1, wherein the second communications link comprises a connection to the remote location that is initiated to transmit the rating feedback, the remote location being linked to the broadcast source.

8. The method of claim 1, wherein the broadcast communications include a schedule for the content descriptors that is received prior to receiving the content descriptors, the schedule providing information pertaining to when the content descriptors may be received.

9. The method of claim 1, wherein the content descriptors comprise a continuous stream of data that may be tapped into at any time to rate at least a portion of the plurality of content pieces via the rating algorithm.

10. The method of claim 1, further comprising:
receiving broadcast communications including the plurality of content pieces; and
performing a capture algorithm to selectively determine which, if any, of the content pieces should be cached, and
wherein the rating algorithm is identical to the capture algorithm.

11. The method of claim 1, wherein the rating algorithm includes a consideration of any existing cached data files to generate the rating feedback.

12. The method of claim 1, wherein the content descriptors include data pertaining to a revenue-generating potential of at least a portion of the content pieces, and the rating algorithm includes a consideration of the content piece's revenue generating potential when generating the rating feedback.

13. The method of claim 1, wherein the rating algorithm includes a consideration of a user's previous viewing habits to generate the rating feedback.

14. The method of claim 1, wherein the rating algorithm includes a consideration of a content piece's size to generate the rating feedback.

15. The method of claim 1, wherein the rating algorithm includes a consideration of a user's preferences to generate the rating feedback.

16. The method of claim 1, wherein the rating algorithm includes a consideration of an availability window corresponding to a content piece to generate the rating feedback.

17. The method of claim 1, wherein the rating algorithm includes a consideration of a future broadcast schedule to generate the rating feedback.

18. The method of claim 1, wherein the rating algorithm includes a consideration of a content piece's past revenue performance to generate the rating feedback.

19. The method of claim 1, wherein the rating algorithm includes a consideration of a review of a content piece provided by an external source to generate the rating feedback.

20. The method of claim 1, wherein the rating algorithm includes a consideration of a content piece's duration to generate the rating feedback.

21. The method of claim 1, wherein the rating algorithm includes a consideration of a user's age to generate the rating feedback.

22. The method of claim 1, further comprising:
generating a display on a display device that provides a user-interface that enables a user to rate content pieces so as to indicate a level of desirability for those content pieces if they are broadcast by the broadcast system.

23. The method of claim 22, wherein the user rates at least a portion of the content pieces.

24. The method of claim 22, wherein the rating algorithm automatically rates at least a portion of the content pieces.

25. The method of claim 23, wherein the rating algorithm automatically rates at least a portion of the content pieces that were not rated by the user.

26. The method of claim 22, wherein the rating algorithm includes a consideration of a user's previous viewing habits to generate the rating feedback.

27. The method of claim 22, wherein the rating algorithm includes a consideration of a content piece's size to generate the rating feedback.

28. The method of claim 22, wherein the rating algorithm includes a consideration of a user's preferences to generate the rating feedback.

29. The method of claim 22, wherein the rating algorithm includes a consideration of an availability window corresponding to a content piece to generate the rating feedback.

30. The method of claim 22, wherein the rating algorithm includes a consideration of a future broadcast schedule to generate the rating feedback.

31. The method of claim 22, wherein the rating algorithm includes a consideration of a content piece's past revenue performance to generate the rating feedback.

32. The method of claim 22, wherein the rating algorithm includes a consideration of a review of a content piece provided by an external source to generate the rating feedback.

33. The method of claim 22, wherein the rating algorithm includes a consideration of a content piece's duration to generate the rating feedback.

34. The method of claim 22, wherein the rating algorithm includes a consideration of a user's age to generate the rating feedback.

35. The method of claim 22, wherein the rating algorithm includes a consideration of any existing cached data files to generate the rating feedback.

36. An apparatus, comprising:
a processor;
a memory, coupled to the processor, to store a plurality of machine instructions including a rating algorithm;
a storage device, coupled to the processor, to store content pieces; and
a communications interface, coupled to the processor, which enables the apparatus to receive broadcast communications from a broadcast source via a first communications link, and to send rating feedback to the broadcast source via a second communications link, the broadcast communications including a plurality of content descriptors that describe a plurality of corresponding content pieces; and
wherein execution of the machine instructions by the processor causes the apparatus to receive the content descriptors as they are broadcast, to perform the rating algorithm to generate the rating feedback, the rating feedback corresponding to at least a portion of the plurality of content pieces, and to transmit the rating feedback to the broadcast source.

37. The apparatus of claim 36, wherein transmitting the rating feedback to the broadcast source comprises periodically transmitting the rating feedback as a batch of rated content pieces via the communications interface.

38. The apparatus of claim 36, wherein the rating feedback comprises a single rated content piece, and wherein transmitting the rating feedback to the broadcast source comprises transmitting the rating feedback in real-time.

39. The apparatus of claim 36, wherein the first communications link and the second communications link comprise a common transmission platform.

40. The apparatus of claim 36, wherein the first communications link and the second communications link comprise separate transmission platforms.

41. The apparatus of claim 36, wherein the communications interface maintains a continuous connection to a remote location to transmit the rating feedback, the remote location being linked to the broadcast source.

42. The apparatus of claim 36, wherein the communications interface initiates a connection to a remote location via a communications link to transmit the rating feedback, the remote location being linked to the broadcast source.

43. The apparatus of claim 36, wherein the broadcast communications include a schedule for the content descriptors that is broadcast prior to sending the content descriptors, and is received via the communications interface, and wherein execution of the plurality of machine instructions further causes the apparatus to prepare for receiving the broadcast of the content descriptors based on the schedule to enable the apparatus to receive the content descriptors when they are broadcast.

44. The apparatus of claim 36, wherein the content descriptors comprise a continuous stream of data that may be tapped into at any time by the communications interface to enable the processor to perform the rating algorithm to rate at least a portion of the plurality of content pieces.

45. The apparatus of claim 36, wherein the plurality of machine instructions further include a capture algorithm, which, when executed by the processor, causes the apparatus to selectively determine which, if any, of the content pieces should be stored in the storage device, and wherein the rating algorithm is identical to the capture algorithm.

46. The apparatus of claim 36, wherein at least one content piece is cached in the storage device, and the rating algorithm considers the at least one content piece that is cached when generating the rating feedback.

47. The apparatus of claim 36, wherein the content descriptors include data pertaining to a revenue-generating potential of at least a portion of the content pieces, and the rating algorithm includes a consideration of the content piece's revenue generating potential when generating the rating feedback.

48. The apparatus of claim 36, wherein the memory stores data pertaining to a user's previous viewing habits, and the rating algorithm includes a consideration of the user's previous viewing habits to generate the rating feedback.

49. The apparatus of claim 36, wherein the content descriptors include data pertaining to a content piece's size, and the rating algorithm includes a consideration of the content piece's size to generate the rating feedback.

50. The apparatus of claim 36, wherein the memory stores data pertaining to a user's preferences, and the rating algorithm includes a consideration of the user's preferences to generate the rating feedback.

51. The apparatus of claim 36, wherein the content descriptors include data pertaining to an availability window corresponding to a content piece, and the rating algorithm includes a consideration of the availability window to generate the rating feedback.

52. The apparatus of claim 36, wherein the content descriptors include data pertaining to a future broadcast schedule, and the rating algorithm includes a consideration of the future broadcast schedule to generate the rating feedback.

53. The apparatus of claim 36, wherein the content descriptors include data pertaining to a content piece's past revenue performance, and the rating algorithm includes a consideration of the content piece's past revenue performance to generate the rating feedback.

54. The apparatus of claim 36, wherein the content descriptors include data pertaining to a review of a content piece provided by an external source, and the rating algorithm includes a consideration of the review to generate the rating feedback.

55. The apparatus of claim 36, wherein the content descriptors include data pertaining to a content piece's duration, and the rating algorithm includes a consideration of the content piece's duration to generate the rating feedback.

56. The apparatus of claim 36, wherein the memory stores data pertaining to a user's age, and the rating algorithm includes a consideration of the user's age to generate the rating feedback.

57. The apparatus of claim 36, wherein the apparatus further includes a video subsystem having an output that generates a display on a display device when the display device is connected to the output, and wherein execution of the plurality of machine instructions by the processor causes the apparatus to provide a user-interface that enables a user to rate content pieces to indicate a level of desirability for receiving those content pieces if they are broadcast by the broadcast system.

58. The apparatus of claim 57, wherein the user rates at least a portion of the content pieces.

59. The apparatus of claim 57, wherein the rating algorithm automatically rates at least a portion of the content pieces.

60. The apparatus of claim 58, wherein the rating algorithm automatically rates at least a portion of the content pieces that were not rated by the user.

61. An article of manufacture, comprising:
a machine-readable medium that provides instructions which, when executed by a machine, cause the machine to:
receive broadcast communications including content descriptors via a first communications link from a broadcast source, the content descriptors including descriptions of a plurality of corresponding content pieces;
perform a rating algorithm to rate at least a portion of the plurality of content pieces to generate a rating feedback; and
transmit the rating feedback via a second communications link to a remote location.

62. The article of manufacture of claim 61, wherein the first communications link and the second communication link comprise a single transmission platform.

63. The article of manufacture of claim 61, wherein the first communications link and the second communications link comprise separate transmission platforms.

64. The article of manufacture of claim 61, wherein the rating feedback comprises a list of rated content pieces, and wherein transmitting the rating feedback comprises periodically transmitting a batch of the rating feedback to the remote location, the remote location being linked to the broadcast source.

65. The article of manufacture of claim 61, wherein the rating feedback comprises a single rated content piece, and wherein transmitting the rating feedback comprises transmitting the rating feedback to the remote location in real-time.

66. The article of manufacture of claim 61, wherein the second communications link comprises a continuous connection to the remote location, the remote location being linked to the broadcast source.

67. The article of manufacture of claim 61, wherein the second communications link comprises a connection to the remote location that is initiated to transmit the rating feedback, the remote location being linked to the broadcast source.

68. The article of manufacture of claim 61, wherein the rating algorithm includes a consideration of any existing cached data files to generate the rating feedback.

69. The article of manufacture of claim 61, wherein the content descriptors include data pertaining to a revenue-generating potential of at least a portion of the content pieces, and the rating algorithm includes a consideration of the content piece's revenue generating potential when generating the rating feedback.

70. The article of manufacture of claim 61, wherein the rating algorithm includes a consideration of a user's previous viewing habits to generate the rating feedback.

71. The article of manufacture of claim 61, wherein the rating algorithm includes a consideration of a content piece's size to generate the rating feedback.

72. The article of manufacture of claim 61, wherein the rating algorithm includes a consideration of a user's preferences to generate the rating feedback.

73. The article of manufacture of claim 61, wherein the rating algorithm includes a consideration of an availability window corresponding to a content piece to generate the rating feedback.

74. The article of manufacture of claim 61, wherein the rating algorithm includes a consideration of a future broadcast schedule to generate the rating feedback.

75. The article of manufacture of claim 61, wherein the rating algorithm includes a consideration of a content piece's past revenue performance to generate the rating feedback.

76. The article of manufacture of claim 61, wherein the rating algorithm includes a consideration of a review of a content piece provided by an external source to generate the rating feedback.

77. The article of manufacture of claim 61, wherein the rating algorithm includes a consideration of a content piece's duration to generate the rating feedback.

78. The article of manufacture of claim 61, wherein the rating algorithm includes a consideration of a user's age to generate the rating feedback.

79. The article of manufacture of claim 61, wherein execution of the instructions by the machine, further cause the machine to generate a display on a display device to provide a user-interface that enables a user to rate content pieces to indicate a level of desirability for receiving those content pieces if they are broadcast by the broadcast system.

80. The article of manufacture of claim 79, wherein the user rates at least a portion of the content pieces.

81. The article of manufacture of claim 79, wherein the rating algorithm automatically rates at least a portion of the content pieces.

82. The article of manufacture of claim 80, wherein the rating algorithm automatically rates at least a portion of the content pieces that were not rated by the user.

83. A method, comprising:
broadcasting broadcast communications including content descriptors from a broadcast source to a plurality of client systems via a first communications link, the content descriptors including descriptions of a plurality of content pieces;
receiving a rating feedback from the plurality of client systems via a second communications link, wherein the rating feedback comprises a rating of at least a portion of the plurality of content pieces.

84. The method of claim 83, wherein the rating feedback comprises a plurality of rated content pieces, and wherein receiving the rating feedback comprises periodically receiving the rating feedback as a batch of rated content pieces from each the plurality of client systems.

85. The method of claim 83, wherein the rating feedback comprises a single rated content piece, and wherein receiving the rating feedback comprises receiving the rating feedback in real-time.

86. The method of claim 83, wherein the first communications link and the second communications link comprise a common transmission platform.

87. The method of claim 83, wherein the first communications link and the second communications link comprise separate transmission platforms.

88. The method of claim 83, wherein the second communications link comprises a continuous connection from each of the plurality of client systems for receiving the rating feedback.

89. The method of claim 83, wherein the second communications link comprises a connection initiated by each of the plurality of client systems.

90. The method of claim 83, wherein the content descriptors comprise a continuous stream of data that may be tapped into at any time to rate at least a portion of the plurality of content pieces.

91. The method of claim 83, wherein the rating of at least a portion of the plurality of content pieces is generated via a rating algorithm.

92. The method of claim 83, wherein the rating feedback includes user rating of content pieces to indicate a level of desirability in receiving those content pieces if they are broadcast by the broadcast system.

93. The method of claim 83, wherein the rating feedback is received from each of the plurality of client systems independently.

94. A broadcast system, comprising:
a server; and
at least one communications link to transmit broadcast communications including content descriptors to a plurality of client systems, the content descriptors including descriptions of a plurality of corresponding content pieces, and to transmit a rating feedback from each of the plurality of client systems to the server, wherein the rating feedback comprises a rating of at least a portion of the plurality of content pieces.

95. The broadcast system of claim 94, wherein the rating feedback is transmitted periodically as a batch of rated content pieces via the at least one communications link from each of the plurality of client systems to the server.

96. The broadcast system of claim 94, wherein the rating feedback comprises a single rated content piece, and wherein the rating feedback is transmitted via the at least one communications link from at least one of the plurality of client systems to the server.

97. The broadcast system of claim 94, wherein the at least one communications link comprises a continuous connection to transmit rating feedback from the plurality of client systems to the server.

98. The broadcast system of claim 94, wherein the at least one communications link comprises a connection from each of the plurality of client systems to the server that is initiated to transmit the rating feedback.

99. The broadcast system of claim 94, wherein the content descriptors comprise a continuous stream of data that may be tapped into at any time to rate at least a portion of the plurality of content pieces.

100. The broadcast system of claim 94, wherein the rating of at least a portion of the plurality of content pieces is generated via a rating algorithm.

101. The broadcast system of claim 94, wherein the rating feedback includes user rating of content pieces to indicate a level of desirability to receive those content pieces if they are broadcast by the broadcast system.

102. The broadcast system of claim 94, wherein the rating feedback is transmitted independently from each of the plurality of client systems to the server.

103. An article of manufacture, comprising:
a machine-readable medium that provides instructions which, when executed by a machine, cause the machine to:
broadcast broadcast communications including content descriptors from a broadcast source to a plurality of client systems via a first communications link, the content descriptors including descriptions of a plurality of content pieces; and
receive a rating feedback from the plurality of client systems via a second communications link, wherein the rating feedback comprises a rating of at least a portion of the plurality of content pieces.

104. The article of manufacture of claim 103, wherein the rating feedback comprises a plurality of rated content pieces, and wherein receiving the rating feedback comprises periodically receiving the rating feedback as a batch of rated content pieces from each of the plurality of client systems.

105. The article of manufacture of claim 103, wherein the rating feedback comprises a single rated content piece, and wherein receiving the rating feedback comprises receiving the rating feedback in real-time.

106. The article of manufacture of claim 103, wherein the first communications link and the second communications link comprise a common transmission platform.

107. The article of manufacture of claim 103, wherein the first communications link and the second communications link comprise separate transmission platforms.

108. The article of manufacture of claim 103, wherein the second communications link comprises a continuous connection from each of the plurality of client systems for receiving the rating feedback.

109. The article of manufacture of claim 103, wherein the second communications link comprises a connection initiated by each of the plurality of client systems.

110. The article of manufacture of claim 103, wherein the rating of at least a portion of the plurality of content pieces is generated via a rating algorithm.

111. The article of manufacture of claim 103, wherein the rating feedback includes user rating of content pieces to indicate a level of desirability to receive those content pieces if they are broadcast by the broadcast system.

112. A system, comprising:
a server;
at least one communications link; and
a client system, the client system including a processor and a memory to store a rating algorithm; and wherein
a plurality of content descriptors are transmitted via the at least one communications link to the client system, the plurality of content descriptors including descriptions of a plurality of content pieces;
the processor implements the rating algorithm to rate at least a portion of the plurality of content pieces to generate a rating feedback; and
the rating feedback is transmitted via the at least one communications link to the server.

113. The system of claim 112, wherein the rating feedback is transmitted periodically via the at least one communications link to the server as a batch of rated content pieces.

114. The system of claim 112, wherein the rating feedback comprises a single rated content piece, and wherein the rating feedback is transmitted via the at least one communications link to the server in real-time.

115. The system of claim 112, wherein the rating feedback includes user rating of the content pieces.

116. The system of claim 112, wherein the rating feedback includes automated rating of the content pieces.

117. The system of claim 112, wherein the rating feedback includes user rating of the content pieces and automated rating of the content pieces.

118. The system of claim 112, wherein the at least one communications link comprises a continuous connection to transmit the rating feedback to the server.

119. The system of claim 112, wherein the at least one communications link comprises a connection initiated by the client system to transmit the rating feedback to the server.

120. A method, comprising:
broadcasting content descriptors from a server to at least one client system via at least one communications link, the content descriptors including descriptions of a plurality of corresponding content pieces;
receiving the content descriptors at the at least one client system;
rating at least a portion of the plurality of content pieces to generate a rating feedback; and
communicating the rating feedback to the server via the at least one communications link.

121. The method of claim 120, further comprising:
processing the rating feedback to generate an aggregate representation of the feedback from the at least one client system; and
selecting a portion of the plurality of content pieces to be sent to the at least one client system in response to the aggregate representation of the feedback.

122. The method of claim 120, wherein communicating the rating feedback to the server comprises periodically communicating a batch of rating feedback.

123. The method of claim 120, wherein the rating feedback comprises a single rated content piece, and wherein communicating the rating feedback to the server comprises communicating the rating feedback in real-time.

124. The method of claim 120, wherein the at least one communications link comprises a continuous connection for communicating the rating feedback to the server.

125. The method of claim 120, wherein the at least one communications link comprises a connection initiated by the at least one client system for communicating the rating feedback to the server.

126. The method of claim 120, wherein the rating feedback includes user rating of the content pieces.

127. The method of claim 120, wherein the rating feedback includes automated rating of the content pieces.

128. The method of claim 120, wherein the rating feedback includes user rating of the content pieces and automated rating of the content pieces.

129. The method of claim 120, wherein the rating feedback is communicated from each at least one client system to the server independently.
